(19) United States
(12) Patent Application Publication
(10) Pub. No.: US 2008/0069125 A1
(43) Pub. Date: Mar. 20, 2008

(54) MEANS AND APPARATUS FOR A SCALABLE CONGESTION FREE SWITCHING SYSTEM WITH INTELLIGENT CONTROL

(75) Inventors: Coke Reed, Austin, TX (US); John Hesse, Moss Beach, CA (US)

Correspondence Address: KEITH D. NOWAK, CARTER LEDYARD & MILBURN LLP, 2 WALL STREET, NEW YORK, NY, 10005, US

(73) Assignee: INTERACTIC HOLDINGS, LLC, Austin, TX (US)

(21) Appl. No.: 11/947,209

(22) Filed: Nov. 29, 2007

Related U.S. Application Data
(63) Continuation of application No. 09/919,462, filed on Jul. 31, 2001, now abandoned.

(51) Int. Cl. H04L 12/28

(52) U.S. Cl. 370/410

(57) ABSTRACT

This invention is directed to a parallel, control-information generation, distribution and processing system. This scalable, pipelined control and switching system efficiently and fairly manages a plurality of incoming data streams, and applies class and quality of service requirements. The present invention also uses scalable MLML switch fabrics to control a data packet switch, including a request-processing switch used to control the data-packet switch. Also included is a request processor for each output port, which manages and approves all data flow to that output port, and an answer switch which transmits answer packets from request processors back to requesting input ports.

### CROSS-REFERENCE TO RELATED APPLICATIONS

The disclosed system and operating method are related to subject matter disclosed in the following patents and patent applications that are incorporated by reference herein in their entirety:

U.S. Pat. No. 6,289,021 (application Ser. No. 09/009,703), issued Sep. 11, 2001, entitled “A Scaleable Low-Latency Switch for Usage in an Interconnect Structure,” naming John Hesse as inventor;

U.S. Pat. No. 5,996,020 (application Ser. No. 08/505,513), issued Nov. 30, 1999, entitled “A Multiple Level Minimum Logic Network,” naming Coke Reed as inventor;

U.S. Pat. No. 6,754,207 (application Ser. No. 09/693,359), issued Jun. 22, 2004, entitled, “Multiple Path Wormhole Interconnect,” naming John Hesse as inventor;

U.S. Pat. No. 6,687,253 (application Ser. No. 09/693,357), issued Feb. 3, 2004 entitled, “Scalable Wormhole-Routing Concentrator,” naming John Hesse and Coke Reed as inventors;

U.S. patent application Ser. No. 09/693,603 entitled, “Scaleable Interconnect Structure for Parallel Computing and Parallel Memory Access,” naming John Hesse and Coke Reed as inventors;

U.S. Pat. No. 7,016,363 (application Ser. No. 09/693,358), issued Mar. 21, 2006, entitled, “Scalable Interconnect Structure Utilizing Quality-Of-Service Handling,” naming Coke Reed and John Hesse as inventors; and

U.S. Pat. No. 7,221,677 (application Ser. No. 09/692,073), issued May 22, 2007 entitled, “Scalable Method and Apparatus for Increasing Throughput in Multiple Level Minimum Logic Networks Using a Plurality of Control Lines” naming Coke Reed and John Hesse as inventors.

### FIELD OF THE INVENTION

The present invention relates to a method and means of controlling an interconnection structure applicable to voice and video communication systems and to data/Internet connections. More particularly, the present invention is directed to the first scalable interconnect switch technology with intelligent control that can be applied to an electronic switch, and an optical switch with electronic control.

### BACKGROUND OF THE INVENTION

There can be no doubt that the transfer of information around the globe will be the driving force for the world's economy in this century. The amount of information currently transferred between individuals, corporations and nations must and will increase substantially. The vital question, therefore, is whether there will be an efficient and low cost infrastructure in place to accommodate the massive amounts of information that will be communicated between numerous parties in the near future. The present invention, as set forth below, answers that question in the affirmative.

In addition to the numerous communication applications, there are numerous other applications enabling a wide variety of products including massively parallel supercomputers, parallel workstations, tightly coupled systems of workstations, and database engines. There are numerous video applications including digital signal processing. The switching systems can also be used in imaging including medical imaging. Other applications include entertainment including video games and virtual reality.

The transfer of information, including voice data and video, between numerous parties on a world-wide basis, depends on the switches which interconnect the communication highways extending throughout the world. Current technology, represented, for example, by equipment supplied by Cisco, allows 16 I/O slots (accommodating, for example, the OC-192 protocol), which provides 160 GBS in total bandwidth. The number of I/O slots can be increased by selective interconnection of existing Cisco switches, but this results in substantially increased costs with a significant decrease in bandwidth per port. Thus, although Cisco switches are currently widely used, it is apparent that current technology, as represented by existing Cisco products, will not be able to accommodate the increasing flood of information that will be flowing over the world's communication highways. A family of patent filings has been created by the assignee of the present invention to alleviate the current and anticipated problems of accommodating the massive amounts of information that will be transferred between parties in the near future. To fully appreciate the substantial advance of the present invention, it is necessary to briefly summarize the prior incorporated inventions, all of which are incorporated herein by reference and are the building blocks upon which the present invention stands.

One such system “A Multiple Level Minimum Logic Network” (MLML network) is described in U.S. Pat. No. 5,996,020, granted to Coke S. Reed on Nov. 30, 1999, (“Invention #1”), the teachings of which are incorporated herein by reference. Invention #1 describes a network and interconnect structure which utilizes a data flow technique that is based on timing and positioning of message packets communicating throughout the interconnect structure. Switching control is distributed throughout multiple nodes in the structure so that a supervisory controller providing a global control function and complex logic structures are avoided. The MLML interconnect structure operates as a “deflection” or “hot potato” system in which processing and storage overhead at each node is minimized. Elimination of a global controller and also elimination of buffering at the nodes greatly reduces the amount of control and logic structures in the interconnect structure, simplifying overall control components and network interconnect components while improving throughput and achieving low latency for packet communication.

More specifically, the Reed Patent describes a design in which processing and storage overhead at each node is greatly reduced by routing a message packet through an additional output port to a node at the same level in the interconnect structure rather than holding the packet until a desired output port is available. With this design the usage of buffers at each node is eliminated.

In accordance with one aspect of the Reed Patent, the MLML interconnect structure includes a plurality of nodes and a plurality of interconnect lines selectively connecting the nodes in a multiple level structure in which the levels include a richly interconnected collection of rings, with the multiple level structure including a plurality of J+1 levels in a hierarchy of levels and a plurality of C·2K nodes at each level (C is a an integer representing the number of angles where nodes are situated). Control information is sent to resolve data transmission conflicts in the interconnect structure where each node is a successor to a node on an adjacent outer level and an immediate successor to a node on the same level. Message data from an immediate predecessor has priority. Control information is sent from nodes on a level to nodes on the adjacent outer level to warn of impending conflicts.

The Reed Patent is a substantial advance over the prior art in which packets proceed through the interconnect structure based on the availability of an input port at a node, leading to the packet's terminal destination. Nodes in the Reed Patent could be capable of receiving a plurality of simultaneous packets at the input ports of each node. However, in one embodiment of the Reed Patent, there was guaranteed availability of only one unblocked node to where an incoming packet could be sent so that in practice, in this embodiment, the nodes in the Reed Patent could not accept simultaneous input packets. The Reed Patent, however, did teach that each node could take into account information from a level more than one level below the current level of the packet, thus, reducing throughput and achieving reduction of latency in the network.

A second approach to achieving an optimum network structure has been shown and described in U.S. patent application Ser. No. 09/009,703 to John E. Hesse, filed on Jan. 20, 1998. (“Invention #2” entitled: “A Scaleable Low Latency Switch for Usage in an Interconnect Structure”). This patent application is assigned to the same entity as is the instant application, and its teachings are also incorporated herein by reference in their entirety. Invention #2 describes a scalable low-latency switch which extends the functionality of a multiple level minimum logic (MLML) interconnect structure, such as is taught in Invention #1, for use in computers of all types, networks and communication systems. The interconnect structure using the scalable low-latency switch described in Invention #2 employs a method of achieving wormhole routing by a novel procedure for inserting packets into the network. The scalable low-latency switch is made up of a large number of extremely simple control cells (nodes) which are arranged into arrays at levels and columns. In Invention #2, packets are not simultaneously inserted into all the unblocked nodes on the top level (outer cylinder) of an array but are inserted a few clock periods later at each column (angle). By this means, wormhole transmission is desirably achieved. Furthermore, there is no buffering of packets at any node. Wormhole transmission, as used here, means that as the first part of a packet payload exits the switch chip, the tail end of the packet has not yet even entered the chip.

Invention #2 teaches how to implement a complete embodiment of the MLML interconnect on a single electronic integrated circuit. This singlechip embodiment constitutes a self-routing MLML switch fabric with wormhole transmission of data packets through it. The scalable low-latency switch of this invention is made up of a large number of extremely simple control cells (nodes). The control cells are arranged into arrays. The number of control cells in an array is a design parameter typically in the range of 64 to 1024 and is usually a power of 2, with the arrays being arranged into levels and columns (which correspond to cylinders and angles, respectively, discussed in Invention #1). Each node has two data input ports and two data output ports wherein the nodes can be formed into more complex designs, such as “paired-node” designs which move packets through the interconnect with significantly lower latency. The number of columns typically ranges from 4 to 20, or more. When each array contains 2J control cells, the number of levels is typically J+1. The scalable lowlatency switch is designed according to multiple design parameters that determine the size, performance and type of the switch. Switches with hundreds of thousands of control cells are laid out on a single chip so that the useful size of the switch is limited by the number of pins, rather than by the size of the network. The invention also taught how to build larger systems using a number of chips as building blocks.

Some embodiments of the switch of this invention include a multicasting option in which one-to-all or one-to-many broadcasting of a packet is performed. Using the multicasting option, any input port can optionally send a packet to many or all output ports. The packet is replicated within the switch with one copy generated per output port. Multicast functionality is pertinent to ATM and LAN/WAN switches, as well as supercomputers. Multicasting is implemented in a straightforward manner using additional control lines which increase integrated circuit logic by approximately 20% to 30%.

The next problem addressed by the family of patents assigned to the assignee of the present invention expands and generalizes the ideas of inventions # 1 and #2. This generalization (Invention #3 entitled: “Multiple Path Wormhole Interconnect”) is carried out in U.S. patent application Ser. No. 09/693,359. The generalizations include networks whose nodes are themselves interconnects of the type described in Invention #2. Also included are variations of Invention #2 that include a richer control system connecting larger and more varying groups of nodes than were included in control interconnects in Inventions #1 and #2. The invention also describes a variety of ways of laying out FIFOs and efficient chip floor planning strategies.

The next advance made by the family of patents assigned to the same assignee as is the present invention is disclosed in U.S. patent application Ser. No. 09/693,357, entitled “Scalable Worm Hole-Routing Concentrator,” naming John Hesse and Coke Reed as inventors. (“Invention #4”)

It is known that communication or computing networks are comprised of several or many devices that are physically connected through a communication medium, for example a metal or fiber optic cable. One type of device that can be included in a network is a concentrator. For example, a large-scale, time-division switching network may include a central switching network and a series of concentrators that are connected to input and output terminals of other devices in the switching network.

Concentrators are typically used to support multi-port connectivity to or from a plurality of networks or between members of plurality of networks. A concentrator is a device that is connected to a plurality of shared communication lines that concentrates information onto fewer lines.

A persistent problem that arises in massively parallel computing systems and in communications systems occurs when a large number of lightly loaded lines send data to a fewer number of more heavily loaded lines. This problem can cause blockage or add additional latency in present systems.

Invention #4 provides a concentrator structure that rapidly routes data and improves information flow by avoiding blockages, that is scalable virtually without limit, and that supports low latency and high throughput. More particularly, this invention provides an interconnect structure which substantially improves operation of an information concentrator through usage of single-bit routing through control cells using a control signal. In one embodiment, message packets entering the structure are never discarded, so that any packet that enters the structure is guaranteed to exit. The interconnect structure includes a ribbon of interconnect lines connecting a plurality of nodes in non-intersecting paths. In one embodiment, a ribbon of interconnect lines winds through a plurality of levels from the source level to the destination level. The number of turns of a winding decreases from the source level to the destination level. The interconnect structure further includes a plurality of columns formed by interconnect lines coupling the nodes across the ribbon in cross-section through the windings of the levels. A method of communicating data over the interconnect structure also incorporates a high-speed minimum logic method for routing data packets down multiple hierarchical levels.

The next advance made by the family of patents assigned to the same assignee as is the present invention is disclosed in U.S. patent application Ser. No. 09/693,603, entitled “Scalable Interconnect Structure for Parallel Computing and Parallel Memory Access,” naming John Hesse and Coke Reed as inventors. (“Invention #5”)

In accordance with Invention 5, data flows in an interconnect structure from an uppermost source level to a lowermost destination level. Much of the structure of the interconnect is similar to the interconnects of the other incorporated patents. But there are important differences; in invention #5, data processing can occur within the network itself so that data entering the network is modified along the route and computation is accomplished within the network itself.

In accordance with this invention, multiple processors are capable of accessing the same data in parallel using several innovative techniques. First, several remote processors can request to read from the same data location and the requests can be fulfilled in overlapping time periods. Second, several processors can access a data item located at the same position, and can read, write, or perform multiple operations on the same data item overlapping times. Third, one data packet can be multicast to several locations and a plurality of packets can be multicast to a plurality of sets of target locations.

A still further advance made by the assignee of the present invention is set forth in U.S. patent application Ser. No. 09/693,358, entitled “Scalable Interconnect Structure Utilizing Quality-of-Service Handling,” naming Coke Reed and John Hesse as inventors (“Invention # 6”).

A significant portion of data that is communicated through a network or interconnect structure requires priority handling during transmission.

Heavy information or packet traffic in a network or interconnection system can cause congestion, creating problems that result in the delay or loss of information. Heavy traffic can cause the system to store information and attempt to send the information multiple times, resulting in extended communication sessions and increased transmission costs. Conventionally, a network or interconnection system may handle all data with the same priority, so that all communications are similarly afflicted by poor service during periods of high congestion. Accordingly, “quality of service” (QOS), has been recognized and defined, which may be applied to describe various parameters that are subject to minimum requirements for transmission of particular data types. QOS parameters may be utilized to allocate system resources such as bandwidth. QOS parameters typically include consideration of cell loss, packet loss, read throughput, read size, time delay or latency, jitter, cumulative delay, and burst sizes. QOS parameters may be associated with an urgent data type such as audio or video streaming information in a multimedia application, where the data packets must be forwarded immediately, or discarded after a brief time period.

Invention #6 is directed to a system and operating technique that allows information with a high priority to communicate through a network or interconnect structure with a high quality of service handling capability. The network of invention #6 has a structure that is similar to the structures of the other incorporated inventions but with additional control lines and logic that give high QOS messages priority over low QOS messages. Additionally, in one embodiment, additional data lines are provided for high QOS messages. In some embodiments of Invention #6, an additional condition is that the quality of service level of the packet is at least a predetermined level with respect to a minimum level of quality of service to descent to a lower level. The predetermined level depends upon the location of the routing node. The technique allows higher quality of service packets to outpace lower quality of service packets early in the progression through the interconnect structure.

A still further advance made by the assignee of the present invention is described in U.S. patent application Ser. No. 09/692,073, entitled “Scalable Method and Apparatus for Increasing Throughput in Multiple Level Minimum Logic Networks Using a Plurality of Control Lines,” naming Coke Reed and John Hesse as inventors (“Invention #7).

In Invention #7, the MLML interconnect structure comprises a plurality of nodes with a plurality of interconnect lines selectively coupling the nodes in a hierarchical multiple level structure. The level of a node within the structure is determined by the position of the node in the structure in which data moves from a source level to a destination level, or alternatively laterally along a level of the multiple level structure. Data messages (packets) are transmitted through the multiple level structure from a source node to one of a plurality of designated destination nodes. Each node included within said plurality of nodes has a plurality of input ports and a plurality of output ports, each node capable of receiving simultaneous data messages at two or more of its input ports. Each node is capable of receiving simultaneous data messages if the node is able to transmit each of said received data messages through separate ones of its output ports to separate nodes in said interconnect structure. Any node in the interconnect structure can receive information regarding nodes more than one level below the node receiving the data messages. In invention #7, there are more control interconnection lines than in the other incorporated invention. This control information is processed at the nodes and allows more messages to flow into a given node than was possible in the other inventions.

The family of patents and patent applications set forth above, are all incorporated herein by reference and are the foundation of the present invention.

It is, therefore, an object of the present invention to utilize the inventions set forth above, to create a scalable interconnect switch with intelligent control that can be used with electronic switches, optical switches with electronic control and fully optical intelligent switches.

It is a further object of the present invention to provide a first true router control utilizing complete system information.

It is another object of the present invention to only discard the lowest priority messages in an interconnect structure when output port overload demands message discarding.

It is a still further object of the present invention to ensure that partial message discarding is never allowed, and that switch fabric overload is always prevented.

It is another object of the present invention to ensure that all types of traffic can be switched, including Ethernet packets, Internet protocol packets, ATM packets and Sonnet Frames.

It is a still further object of the present invention to provide an intelligent optical router that will switch all formats of optical data.

It is a further object of the present invention to provide error free methods of handling teleconferencing, as well as providing efficient and economical methods of distributing video or video-on-demand movies.

It is a still further and general object of the present invention to provide a low cost and efficient scalable interconnect switch that far exceeds the bandwidth of existing switches and can be applied to electronic switches, optical switches with electronic control and fully optical intelligent switches.

### BRIEF SUMMARY OF THE INVENTION

There are two significant requirements associated with implementing a large Internet switch that are not feasible to implement using prior art. First, the system must include a large, efficient, and scalable switch fabric, and second, there must be a global, scalable method of managing traffic moving into the fabric. The patents incorporated by reference describe highly efficient, scalable MLML switch fabrics that are self routing and nonblocking. Moreover, in order to accommodate bursty traffic these switches allow multiple packets to be sent to the same system output port during a given time step. Because of these features, these standalone networks desirably provide a scaleable, self-managed switch fabric. In systems with efficient global traffic control that ensure that no link in the system is overloaded except for bursts, the standalone networks described in the patents incorporated by reference satisfy the goals of scalability and local manageability. But there are still problems that must be addressed.

In real-life conditions, global traffic management is less than optimal, so that for a prolonged time traffic can enter the switch in such a way that one or more output lines from the switch become overloaded. An overload condition can occur when a plurality of upstream sources simultaneously send packets that have the same downstream address and continue to do so for a significant time duration. The resulting overload is too severe to be handled by reasonable amounts of local buffering. It is not possible to design any kind of switch that can solve this overload condition without discarding some of the traffic. Therefore, in a system where upstream traffic conditions causes this overload to occur there must be some local method for equitably discarding a portion of the offending traffic while not harming other traffic. When a portion of the traffic is discarded it should be the traffic with low value or quality of service rating.

In the following description the term “packet” refers to a unit of data, such as an Internet Protocol (IP) packet, an Ethernet frame, a SONET frame, an ATM cell, a switch-fabric segment (portion of a larger frame or packet), or other data object that one desires to transmit through the system. The switching system disclosed here controls and routes incoming packets of one or more formats.

In the present invention, we show how the interconnect structures, described in patents incorporated by reference, can be used to manage a wide variety of switch topologies, including crossbar switches given in prior art. Moreover, we show how we can use the technologies taught in the patents incorporated by reference to manage a wide range of interconnect structures, so that one can build a scaleable, efficient interconnect switching systems that handle quality and type of service, multicasting, and trunking. We also show how to manage conditions where the upstream traffic pattern would cause congestion in the local switching system. The structures and methods disclosed herein manage fairly and efficiently any kind of upstream traffic conditions, and provide a scalable means to decide how to manage each arriving packet while never allowing congestion in downstream ports and connections.

Additionally, there are I/O functions that are performed by line card processors, sometimes called network processors, and physical medium attachment components. In the following discussion it is assumed that the functions of packet detection, buffering, header and packet parsing, output address lookup, priority assignment and other typical I/O functions are performed by devices, components and methods given in common switching and routing practice. Priority can be based on the current state of control in switching system 100 and information in the arriving data packet, including type of service, quality of service, and other items related to urgency and value of a given packet. This discussion mainly pertains to what happens to an arriving packet after it has been determined (1) where to send it, and (2) what are its priority, urgency, class, and type of service.

The present invention is a parallel, control-information generation, distribution, and processing system. This scalable, pipelined control and switching system efficiently and fairly manages a plurality of incoming data streams, and apply class and quality of service requirements. The present invention uses scalable MLML switch fabrics of the types taught in the incorporated inventions to control a data packet switch of a similar type or of a dissimilar type. Alternately stated, a request-processing switch is used to control a data-packet switch: the first switch transmits requests, while the second switch transmits data packets.

An input processor generates a request-to-send packet when it receives a data packet from upstream. This request packet contains priority information about the data packet. There is a request processor for each output port, which manages and approves all data flow to that output port. The request processor receives all requests packets for the output port. It determines if and/or when the data packet may be sent to the output port. It examines the priority of each request and schedules higher priority or more urgent packets for earlier transmission. During overload at the output port, it rejects low priority or low value requests. A key feature of the invention is the joint monitoring of messages arriving at more than one input port. It is not important that there is a separate logic associated with each output port or if the joint monitoring is done in hardware or software. What is important is that there exists a means for information concerning the arrival of a packet MA at input port A and information concerning the arrival of packet MB at input port B to be jointly considered.

A third switch called the answer switch, is similar to the first, and transmits answer packets from the request processors back to the requesting input ports. During an impending overload at an output, a request can harmlessly be discarded by the request processor. This is because the request can easily be generated again at a later time. The data packet is stored at the input port until it is granted permission to be sent to the output; low-priority packets that do not receive permission during overload can be discarded after a predetermined time. An output port can never become overloaded because the request processor will not allow this to happen. Higher priority data packets are permitted to be sent to the output port during overload conditions. During an impending overload at an output port, low priority packets cannot prevent higher priority packets from being sent downstream.

Input processors receive information only from the output locations that they are sending to; request processors receive requests only from input ports that wish to send to them. All these operations are performed in a pipelined, parallel manner. Importantly, the processing workload for a given input port processor and for a given request processor does not increase as the total number of I/O ports increases. The scalable MLML switch fabrics that transmit the requests, answers and data, advantageously maintain the same per-port throughput, regardless of number of ports. Accordingly, this information generation, processing, and distribution system is without any architectural limit in size.

The congestion-free switching system consists of a data switch 130 and a scalable control system that determines if and when packets are allowed to enter the data switch. The control system consists of the set of input controllers 150, the request switch 104, and the set of request processors 106, the answer switch 108, and the output controller 110. In one embodiment, there is one input port controller, IC 150, and one request processor, RP 106, for each output port 128 of the system. Processing of requests and responses (answers) in the control system occurs in overlapped fashion with transmission of data packets through the data switch. While the control system is processing requests for the most recently arriving data packets, the data switch performs its switching function by transmitting data packets that received positive responses during a previous cycle.

Congestion in the data switch is prevented by not allowing any traffic into the data switch that would cause congestion. Generally stated, this control is achieved by using a logical “analog” of the data switch to decide what to do with arriving packets. This analog of the data switch is called the request controller 120, and contains a request switch fabric 104 usually with at least the same number of ports as the data switch 130. The request switch processes small request packets rather than the larger data packets that are handled by the data switch. After a data packet arrives at an input controller 150, the input controller generates and sends a request packet into the request switch. The request packet includes a field that identifies the sending input controller and a field with priority information. These requests are received by request processors 106, each of which is a representative for an output port of the data switch. In one embodiment, there is one request processor for each data output port.

One of the functions of the input controllers is to break up arriving data packets into segments of fixed length. An input controller 150 inserts a header containing the address 214 of the target output port in front of each of the segments, and sends these segments into data switch 130. The segments are reassembled into a packet by the receiving output controller 110 and sent out of the switch through an output port 128 of line card 102. In a simple embodiment that is suitable for a switch in which only one segment can be sent through line 116 in a given packet sending cycle, the input controllers make a request to send a single packet through the data switch A request processor either grants or denies permission to the input controller for the sending of its packet into the data switch. In a first scheme, the request processors grant permission to send only a single segment of a packet; in a second scheme, the request processors grant permission for the sending of all or many of the segments of a packet. In this second scheme the segments are sent one after another until all or most of the segments have been sent. The segments making up one packet might be sent continuously without interruption, or each segment might be sent in a scheduled fashion as described with FIG. 3C, thus allowing other traffic to be attended to. The second scheme has the advantage that input controllers make fewer requests and therefore, the request switch is less busy.

During a request cycle, a request processor 106 receives, zero, one, or more request packets. Each request processor receiving at least one request packet ranks them by priority and grants one or more requests and may deny the remaining requests. The request processor immediately generates responses (answers) and sends them back to the input controllers by means of a second switch fabric (preferably an MLML switch fabric), called the answer switch, AS 108. The request processors send acceptance responses corresponding to the granted requests. In some embodiments, rejection responses are also sent. In another embodiment, the requests and answers contain scheduling information. The answer switch connects the request processors to the input controllers. An input controller that receives an acceptance response is then allowed to send the corresponding data packet segment or segments into the data switch at the next data cycle or cycles, or at the scheduled times. An input controller receiving no acceptances does not send a data packet into the data switch. Such an input controller can submit requests at later cycles until the packet is eventually accepted, or else the input controller can discard the data packet after repeated denied requests. The input controller may also raise the priority of a packet as it ages in its input buffer, advantageously allowing more urgent traffic to be transmitted.

In addition to informing input processors that certain requests are granted, the request processor may additionally inform request processors that certain requests are denied. Additional information may be sent in case a request is denied. This information about the likelihood that subsequent requests will be successful can include information on how many other input controllers want to send to the requested output port, what is the relative priority of other requests, and recent statistics regarding how busy the output port has been. In an illustrative example, assume a request processor receives five requests and is able to grant three of them. The amount of processing performed by this request processor is minimal: it has only to rank them by priority and, based on the ranking, send off three acceptance response packets and two rejection response packets. The input controllers receiving acceptances send their segments beginning at the next packet sending time. In one embodiment, an input controller receiving a rejection might wait a number of cycles before submitting another request for the rejected packet. In other embodiments, the request processor can schedule a time in the future for request processors to send segment packets through the data switch.

A potential overload situation occurs when a significant number of input ports receive packets that must be sent downstream through a single output port. In this case, the input controllers independently, and without knowledge of the imminent overload, send their request packets through the request switch to the same request processor. Importantly, the request switch itself cannot become congested. This is because the request switch transmits only a fixed, maximum number of requests to a request processor and discards the remaining requests within the switch fabric. Alternately stated, the request switch is designed to allow only a fixed number of requests through any of its output ports. Packets above this number may temporarily circulate in the request switch fabric, but are discarded after a preset time, preventing congestion in it. Accordingly, associated with a given request, an input controller can receive an acceptance, a rejection, or no response. There are a number of possible responses including:
send only one segment of the packet at the next segment sending time,
send all of the segments sequentially beginning at the next sending time,
send all of the segments sequentially beginning at a certain future time prescribed by the request processor,
send the segments in the future with a prescribed time for each segment,
do not send any segments into the data switch,
do not send any segments into the data switch and wait at least for a specified amount of time before resubmitting the request, because either a rejection response is returned or no response is returned, indicating the request was lost on account of too many requests submitted to that request processor.

An input controller receiving a rejection for a data packet retains that data packet in its input buffer and can regenerate another request packet for the rejected packet at a later cycle. Even if the input controller must discard request packets the system functions efficiently and fairly. In an illustrative example of extreme overloading, assume 20 input controllers wish to send a data packet to the same output port at the same time. These 20 input controllers each send a request packet to the request processor that services that output port. The request switch forwards, say, five of them to the request processor and discards the remaining 15. The 15 input controllers receive no notification at all, indicating to them that a severe overload condition exists for this output port. In a case where three of the five requests are granted and two are denied by the request processor, the 17 input controllers that receive rejection responses or no responses can make the requests again in a later request cycle.

“Multiple choice” request processing allows an input controller receiving one or more denials to immediately make one or more additional requests for different packets. A single request cycle has two or more subcycles, or phases. Assume, as an example, that an input controller has five or more packets in its buffer. Assume moreover, that the system is such that in a given packet sending cycle, the input controller can send two packet segments through the data switch. The request processor selects the two packets with the highest-ranking priority and sends two requests to the corresponding request processors. Assume moreover, that the request processor accepts one packet and denies the other. The input controller immediately sends another request for another packet to a different request processor. The request processor receiving this request will accept or deny permission for the input controller to send a segment of the packet to the data switch. The input controller receiving rejections may thus be allowed to send second-choice data packets, advantageously draining its buffer, whereas it otherwise would have had to wait until the next full request cycle. This request-and-answer process is completed in the second phase of a request cycle. Even though requests denied in the first round are held in the buffer, other requests accepted in the first and second rounds can be sent to the data switch. Depending on traffic conditions and design parameters, a third phase can provide yet another try. In this way, input controllers are able to keep data flowing out of their buffers. Therefore, in case an input controller can send N packet segments through lines 116 of the data switch at a given time, the input controller can make up to N simultaneous requests to the request processors in a given request cycle. In case K of the requests are granted, the input controllers may make a second request to send a different set of N-K packets through the data switch.

In an alternate embodiment, an input controller provides the request processor with a schedule indicating when it will be available for sending a packet into the data switch. The schedule is examined by the request processor, in conjunction with schedule and priority information from other requesting input processors and with its own schedule of availability of the output port. The request processor informs an input processor when it must send its data into the switch. This embodiment reduces the workload of the control system, advantageously providing higher overall throughput. Another advantage of the schedule method is that request processors are provided with more information about all the input processors currently wanting to send to the respective output port, and accordingly can make more informed decisions as to which input ports can send at which times, thus balancing priority, urgency, and current traffic conditions in a scalable means.

Note that, on average, an input controller will have fewer packets in its buffer than can be sent simultaneously into the data switch, and thus the multiple-choice process will rarely occur. However and importantly, an impending congestion is precisely the time when the global control system disclosed herein is most needed to prevent congestion in the data switch and to efficiently and fairly move traffic downstream, based on priority, type and class of service, and other QOS parameters.

In embodiments previously described, if a packet is refused entry into the data switch, then at a later time the input controller may resubmits the request at a later time. In other embodiments, the request processor remembers that the request has been sent and later grants permission to send when an opportunity is available. In some embodiments, the request processor only sends acceptance responses. In other embodiments, the request processor answers all requests. In this case, for each request that arrives at a request processor, the input controller gets an answer packet from the request processor. In case the packet is denied, this information could give a time segment T so that the request processor must wait for a time duration T before resubmitting a request. Alternatively, the request processor could give information describing the status of competing traffic at the request processor. This information is delivered to all input controllers, in parallel, by the control system and is always current and up to date. Advantageously, an input controller is able to determine how likely a denied packet will be accepted and how soon. Extraneous and irrelevant information is neither provided nor generated. The desirable consequence of this method of parallel information delivery is that each input controller has information about the pending traffic of all other input controllers wishing to send to a common request processor, and only those input controllers.

As an example, during an overload condition an input controller may have four packets in its buffer that have recently had requests denied. Each of the four request processors has sent information that will allow the input controller to estimate the likelihood that each of the four packets will be accepted at a later time. The input controller discards packets or reformulates its requests based on probability of acceptance and priority, to efficiently forward traffic through system 100. The control system disclosed herein importantly provides each input controller with all the information it needs to fairly and equitably determine which traffic to send into the switch. The switch is never congested and performs with low latency. The control system disclosed here can easily provide scalable, global control for switches described in the patents incorporated by reference, as well as for switches such as the crossbar switch.

Input controllers make requests for data that is “at” the input controller. This data can be part of a message that has arrived while additional data from the message has yet to arrive, it can consist of whole messages stored in buffers at the input port or it can consist of segments of a message where a portion of the message has already been sent through the data switch. In the embodiments previously described, when an input controller makes a request to send data to the data switch, and the request is granted then the data is always sent to the data switch. So, for example, if the input controller has 4 data carrying lines into the data switch, it will never make requests to use 5 lines. In another embodiment, the input controller makes more requests than it can use. The request processors honor a maximum of one request per input controller. If the input controller receives multiple acceptances, it schedules one packet to be sent into the switch and on the next round makes all of the additional requests a second time. In this embodiment, the output controllers have more information to base their decisions upon and are therefore able to make better decisions. However, in this embodiment, each round of the request procedure is more costly. Moreover, in a system with four lines from the input controllers to the data switch and where time scheduling is not employed, it is necessary to make at least four rounds of requests per data transmission.

Additionally, there needs to be a means for carrying out multicasting and trunking. Multicasting refers to the sending of a packet from one input port to a plural number of output ports. However, a few input ports receiving lots of multicast packets can overload any system. It is therefore necessary to detect excessive multicasting, limit it, and thereby prevent congestion. As an illustrative example, an upstream device in a defect condition can transmit a continuous series of multicast packets where each packet would be multiplied in the downstream switch, causing immense congestion. The multicast request processors discussed later detect overload multicasting and limit it when necessary. Trunking refers to the aggregation of multiple output ports connected to the same downstream path. A plurality of data switch output ports are typically connected downstream to a high-capacity transmission medium, such as an optical fiber. This set of ports is often referred to as a trunk. Different trunks can have different numbers of output ports. Any output port that is a member of the set can be used for a packet going to that trunk. A means of trunking support is disclosed herein. Each trunk has a single internal address in the data switch. A packet sent to that address will be sent by the data switch to an available output port connected to the trunk, desirably utilizing the capacity of the trunk medium.

### BRIEF DESCRIPTION OF THE SEVERAL VIEWS OF THE DRAWINGS

FIG. 1A is a schematic block diagram showing an example of a generic system constructed from building blocks including input processors and buffers, output processors and buffers, network interconnect switches that are used for traffic management and control, and a network interconnect switch that is used for switching data to target output ports.

FIG. 1B is a schematic block diagram of input control units. FIG. 1C is a schematic block diagram of output control units. FIG. 1D is a schematic block diagram showing a system processor and its connections to the switching systems and external devices.

FIG. 1E is a schematic block diagram showing an example of a full system of the type shown in FIG. 1A where the request switch and data switch system are combined in a single component, which advantageously can simplify processing in certain applications, and reduce the amount of circuitry needed to implement the system.

FIG. 1F is a schematic block diagram showing an example of a full system of the type shown in FIG. 1A where the request switch, answer switch and data switch system are combined in a single component, which advantageously reduces the amount of circuitry needed to implement the system in certain applications.

FIGS. 2A through 2L are diagrams showing formats of packets used in various components of the switching system and for various embodiments of the system.

FIGS. 3A and 3B are diagrams showing formats of packets used in various components for time-slot reservation scheduling of packets. FIG. 3C is a diagram of a method of time slot reservation showing how input processors request to transmit at specified time periods in the future, how the request processor receives them, and how the request processor replies to the requesting input processors informing them when they can send.

FIG. 4A is a schematic block diagram of input control units with multicast capability. FIG. 4B is a schematic block diagram showing a request controller with multicast capability. FIG. 4C is a schematic block diagram showing a data switch with multicast capability.

FIG. 5A is a schematic block diagram showing an example of the system in FIG. 1 with an alternate means of multicast support in the control system. FIG. 5B is a schematic block diagram showing an alternate means of multicast support in the data switch fabric.

FIG. 6A is a generalized timing diagram showing overlapped processing of major components of the control and switching system. FIG. 6B is a more detailed an example of timing diagram showing overlapped processing of control system components.

FIG. 6C is a timing diagram that illustrates a multicast timing scheme where multicast requests are made only at designated time periods.

FIG. 6D is a generalized timing diagram of an embodiment of a control system that supports the time-slot reservation scheduling discussed with FIGS. 3A, 3B and 3C.

FIG. 7 is a diagram showing configurable output connections of an electronic switch to advantageously provide flexibility in dynamically matching traffic requirements to physical embodiment.

FIG. 8 is a circuit diagram of the bottom levels of an electronic MLML switch fabric that supports trunking in the nodes.

FIG. 9 is a schematic block diagram of a design that provides high bandwidth by employing a plural number of data switches corresponding to a single control switch.

FIG. 10A is a schematic block diagram showing multiple systems 100 connected in layers to a set of line cards to increase system capacity and speed in a scalable manner.

FIG. 10B illustrates a modification of the system of FIG. 10A where a plurality of output controllers is combined into a single unit.

FIG. 11A is a schematic block diagram of a twisted-cube data switch with concentrators employed between the switches.

FIG. 11B is a schematic block diagram of a twisted-cube data switch and a control system including a twisted cube.

FIG. 11C is a schematic block diagram of a twisted-cube system with two levels of management.

FIG. 12A is a schematic diagram of a node that has two data paths from the east and two data paths from north and two data paths to the west and two data paths to the south.

FIG. 12B is a schematic block diagram that shows a plurality of data paths from the east and to the west, with different paths for each of short, medium, long and extremely long packets.

FIG. 13A is a timing diagram for nodes of the type illustrated in FIG. 12A.

FIG. 13B is a timing diagram for nodes of the type illustrated in FIG. 12B.

FIG. 14 is a circuit diagram of a portion of a switch supporting the simultaneous transmission of packets of different lengths, and connections showing nodes in two columns and two levels of the MLML interconnect fabric.

### DETAILED DESCRIPTION OF THE INVENTION

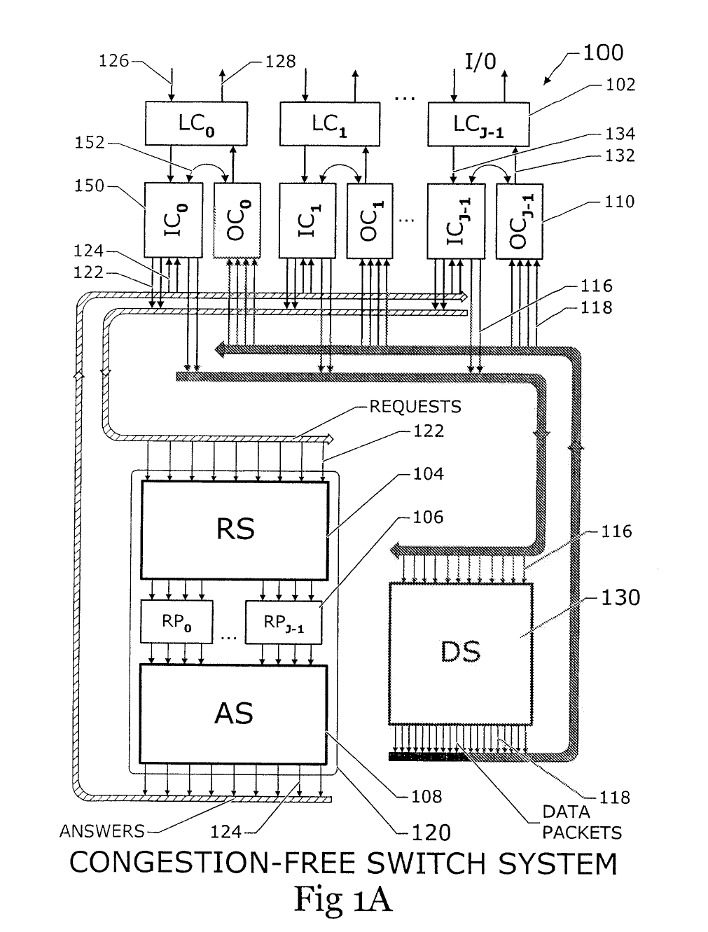

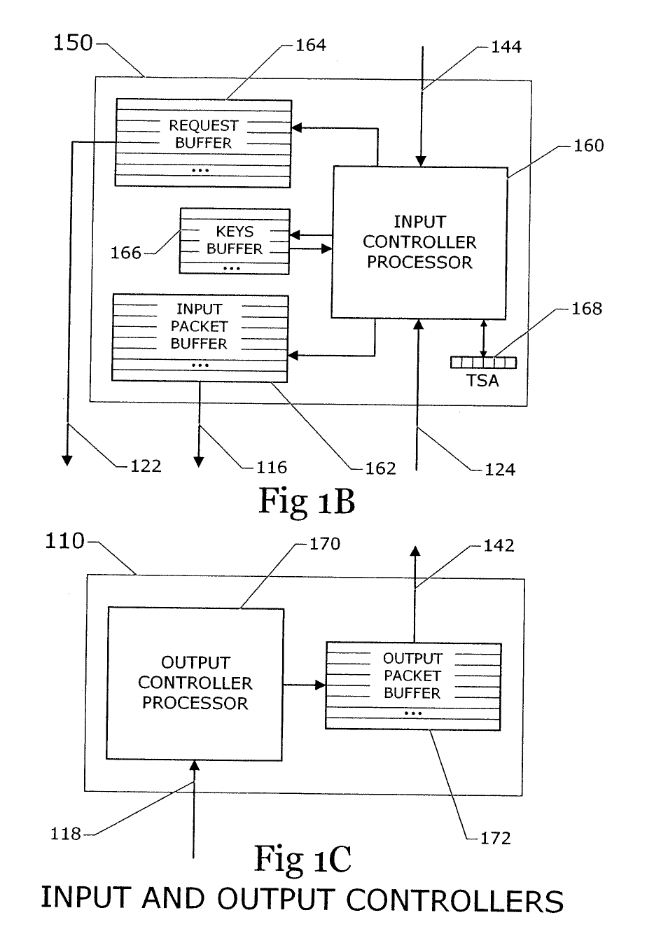

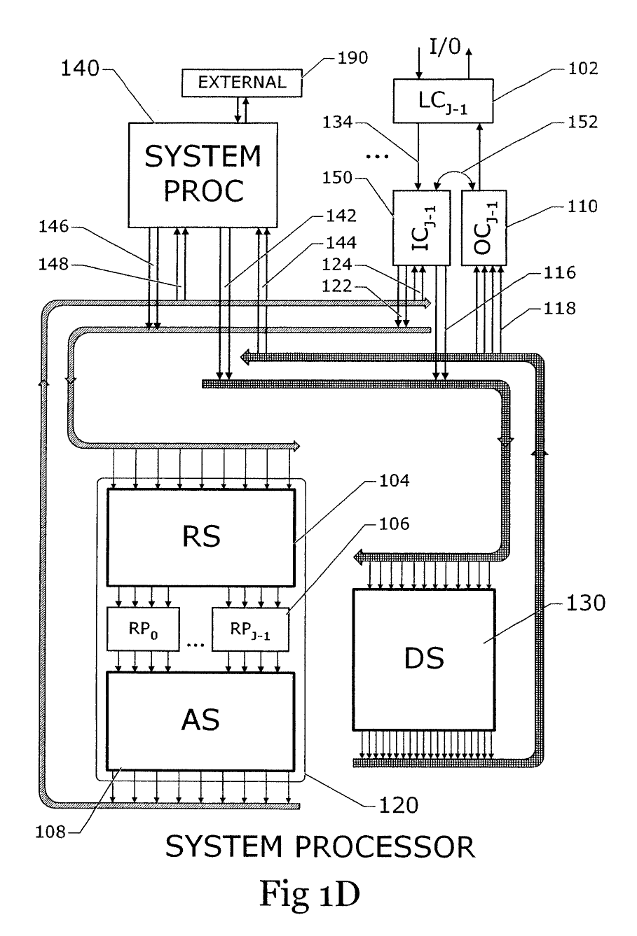

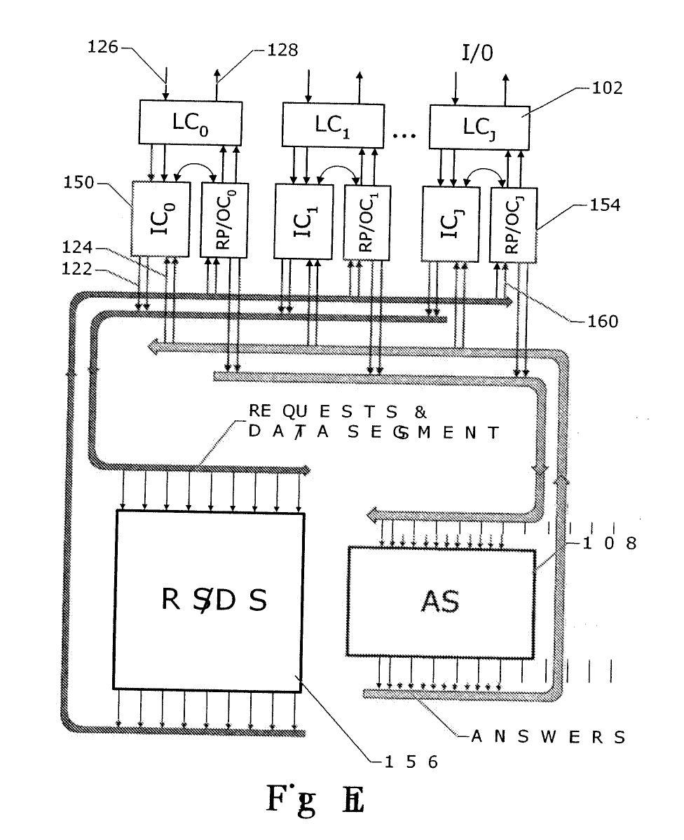

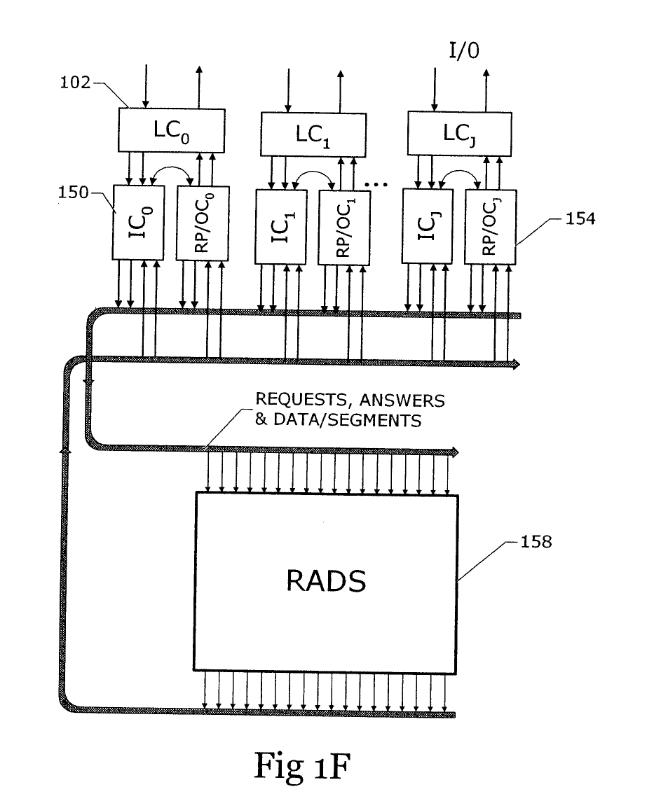

FIG. 1 depicts a data switch 130 and control system 100 connected to a plurality of line cards 102. The line cards send data to the switch and control system 100 through input lines 134 and receive data from the switch and control system 100 through lines 132. The line cards receive and send data to the outside world through a plurality of externally connected input lines 126 and output lines 128. Interconnect system 100 receives and sends data. All of the packets enter and leave the system 100 through the line cards 102. Data entering system 100 is in the form of packets of various lengths. The J line cards are denoted by LCₒ, LC₁, . . . LC_{J-1}.

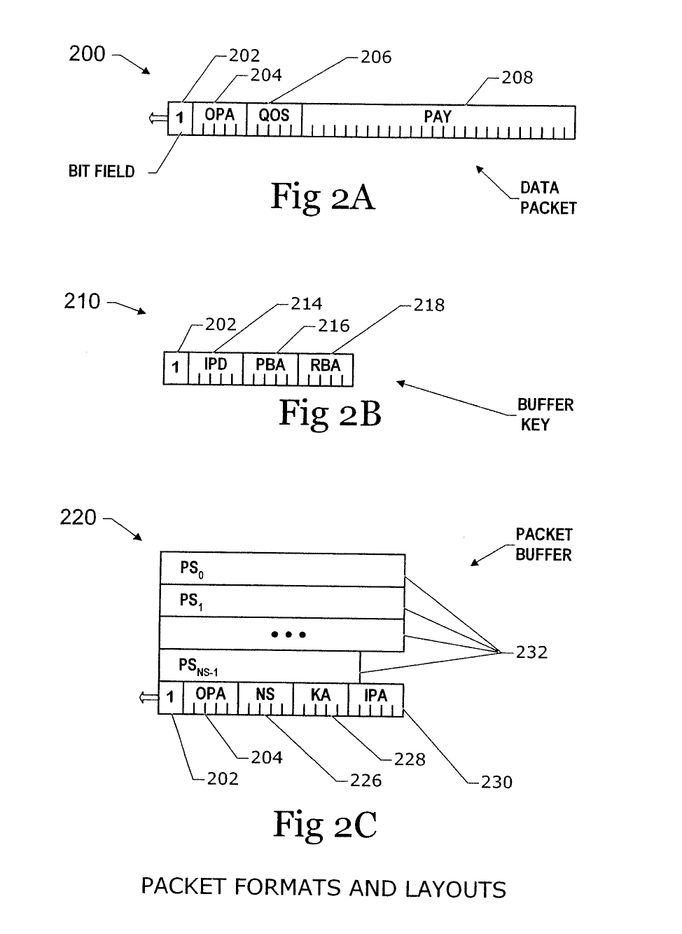

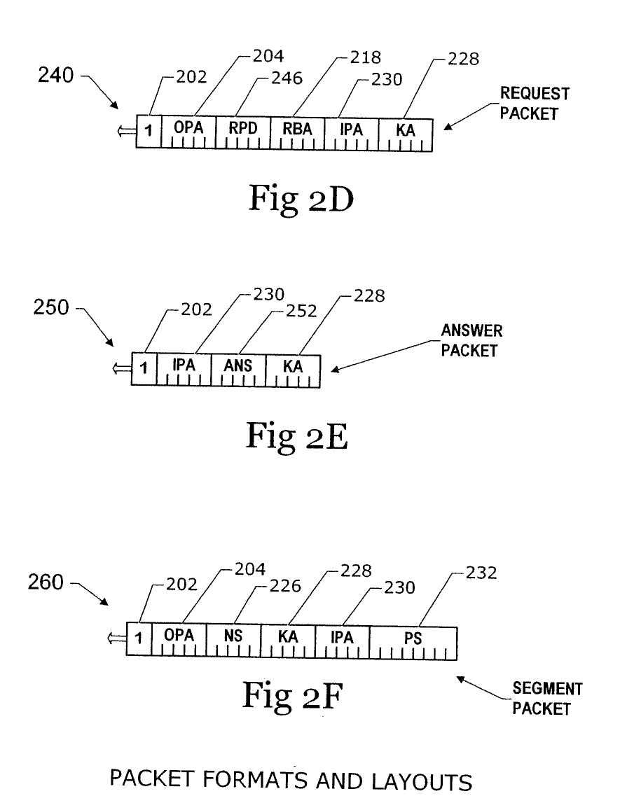

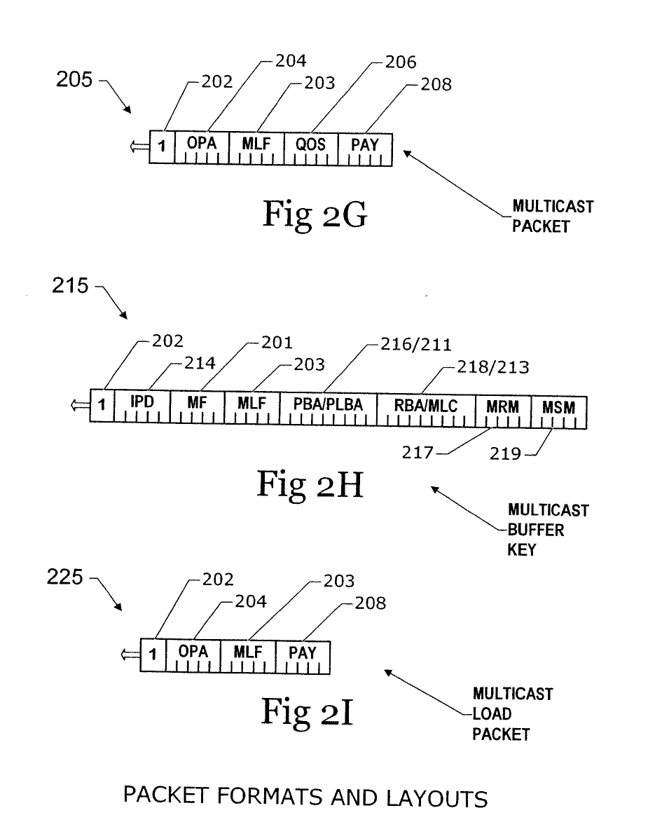

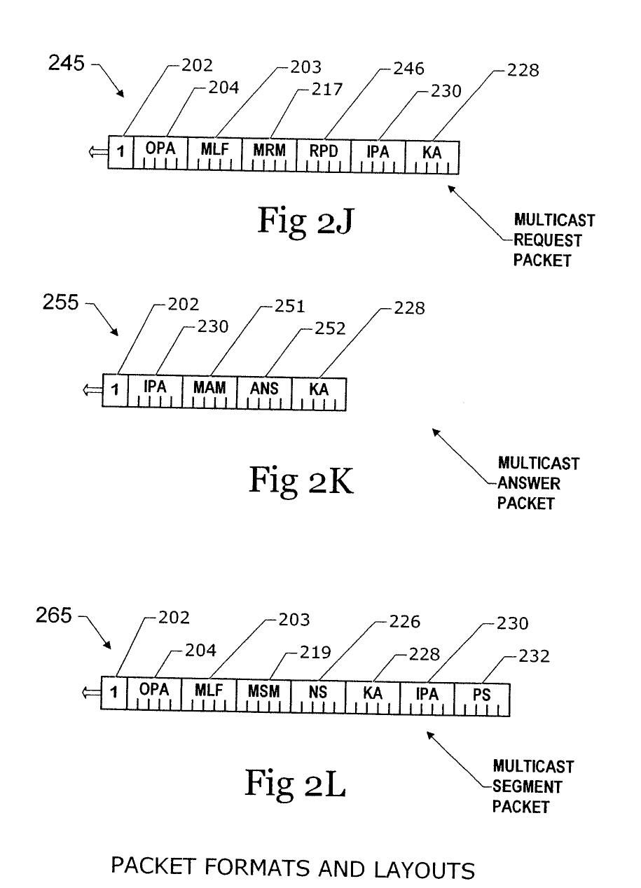

The line cards perform a number of functions. In addition to performing I/O functions pertaining to standard transmission protocols given in prior art, the line cards use packet information to assign a physical output port address 204 and quality of service (QOS) 206 to packets. The line cards build packets in the format shown in FIG. 2A. The packet 200 consists of the four fields: BIT 202, OPA 204, QOS 206, and PAY 208. The BIT field is a one-bit field that is always set to 1 and indicates the presence of a packet. The output address field, OPA 204, contains the address of the target output. In some embodiments, the number of target outputs is equal to the number of line cards. In other embodiments; the data switch may have more output addresses than the number of line cards. The QOS field indicates the quality of service type. The PAY field contains the payload to be sent through data switch 130 to the output controller 110 specified by the OPA address. Generally stated, the incoming packet may be considerably larger than the PAY field. Segmentation and reassembly (SAR) techniques are used to subdivide the incoming packet into a plurality of segments. In some embodiments, all of the segments are of the same length, in other embodiments; segments may be of different lengths. Each segment is placed in the PAY field of a series of transmissions of packets 200 through the data switch. The output controller performs reassembly of the segments, and forwards the complete packet downstream through the line card. By this method, system 100 is able to accommodate payloads varying widely in length. The line card generates the QOS field from information in the header of the arriving packet. Information needed to construct QOS fields may remain in the PAY field. If this is the case, system 100 can discard the QOS field when it is no longer used, and a line card downstream can obtain quality of service information from the PAY field.

FIG. 2 shows the formatting of data in various packets.

| | |
|---|---|
| ANS | Answer from the request processor to the input controller granting |
| | permission for the input controller to send the packet segments to the data |
| | switch DS 130. |
| BIT | A one-bit field that is set to 1 when there is data in the packet. When set to |
| | 0 the remaining fields are ignored. |
| IPA | Input port address. |
| IPD | Input port data, used by the input processor in deciding which packets to |
| | send to the request processors. |
| KA | Address of the packet KEY in the keys buffer 166. This address, along |
| | with the input port address, is a unique packet identifier. |
| NS | Number of segments of a given packet stored in the packet buffer. This |
| | number is decremented when a segment packet is sent from the packet |
| | buffer to the output port. |
| OPA | The output port address is the address of |
| | The target output port, |
| | The output controller processor associated with the target output port, or |
| | The request processor associated with the target output port. |
| PAY | The field containing the payload. |
| PBA | Packet buffer address 162, where the packets are stored. |
| PS | A segment of the packet. |
| QOS | A quality-of-service value, or priority value, assigned to the packet by the |
| | line card. |
| RBA | Request buffer address, where a given request packet is stored. |
| RPD | Request processor data, used to determine which packets are allowed to be |
| | sent through the data switch. |

The line cards 102 send packet 200, illustrated in FIG. 2A, to an input controller 150 through transmission line 134. The input controllers are denoted by IC0, IC1, . . . ICJ−1. In this embodiment the number of input controllers is set equal to the number of line cards. In some embodiments an input controller may handle a plurality of line cards.

A listing of the functions performed by the input controllers and output controllers provides an overview of the workings of the entire system. The input controllers 150 perform at least the following six functions:

1. they break the long packets into segment lengths that can be conveniently handled by the data switch,

2. they generate control information that they use and also control information to be used by the request processors,

3. they buffer incoming packets,

4. they make requests to the request processor for permission to send packets through the data switch,

5. they receive and process answers from request processors, and

6. they send packets through the data switch.

The output controllers 110 perform the following three functions:

1. they receive and buffer packets or segments from the data switch,

2. they reassemble segments received from the data switch into full data packets to send to the line cards, and

3. they send the reassembled packets to the line cards.

The control system is made up of input controllers 150, request controller 120, and output controller 110. Request controller 120 is made up of request switch 104, a plurality of request processors 106, and answer switch 108. The control system determines if and when a packet or segment is to be sent into the data switch. Data switch fabric 130 routes segments from input controllers 150 to output controllers 110. A detailed description of the control and switching structures, and control methods follows.

The input controller does not immediately send an incoming packet P on line 116 through the data switch to the output port designated in the header of P. This is because there is a maximum bandwidth on path 118 from the data switch to the output port leading to the target of P, and a plurality of inputs may have packets to send to the same output port at one time. Moreover there is a maximum bandwidth on path 116 from an input controller 150 to data switch 130, a maximum buffer space at an output controller 110, and a maximum data rate from the output controller to the line card. Packet P must not be sent into the data switch at a time that would cause an overload in any of these components. The system is designed to minimize the number of packets that must be discarded. However, in the embodiment discussed here, if it is ever necessary to discard a packet, the discarding is done at the input end by the input controller rather than at the output end. Moreover, the data is discarded in a systematic way, paying careful attention to quality of service (QOS) and other priority values. When one segment of a packet is discarded, the entire packet is discarded. Therefore, each input controller that has packets to send needs to request permission to send, and the request processors grant this permission.

When a packet P 200 enters an input controller through line 134, the input controller 150 performs a number of operations. Refer to FIG. 1B for a block diagram of internal components of an exemplary input controller and an output controller. Data in the form of a packet 200 illustrated in FIG. 2A enters an input controller processor 160 from the line card. The PAY field 208 contains the IP packet, Ethernet frame, or other data object received by the system. The input controller responds to arriving packet P by generating internally used packets and stores them in its buffers 162, 164 and 166. There are numerous ways to store the data associated with incoming packet P. A method presented in the present embodiment is to store the data associated with P in three storage areas:

1. the packet buffer 162 that is used for storing input segments 232 and associated information,

2. the request buffer 164, and

3. the keys buffer 166, containing KEYs 210.

In preparing and storing data in the KEYs buffer 166, the input controller processes routing and control information associated with arriving packet P. This is the KEY 210 information that the input controller uses in deciding which requests to send to the request controller 120. Data in the form given in FIG. 2B are referred to as a KEYs 210 and are stored in the keys buffer 166 at the KEY address. BIT field 202 is a one-bit-long field that is set to 1 to indicate the presence of a packet. IPD field 214 contains the control information data that is used by input controller 160 in deciding what requests to make to request controller 120. The IPD field may contain a QOS field 206 as a sub-field. Additionally, the IPD field may contain data indicating how long the given packet has been in the buffer and how full the input buffers are. The IPD may contain the output port address and other information that the input controller processor uses in deciding what requests to submit. The PBA field 216 is the packet buffer address field and contains the physical location of the beginning of the data 220 associated with packet P in message buffer 162. The RBA field 218 is the request buffer address field that gives the address of the data associated with packet P in the request buffer 164. The data stored at the address “key address” in buffer 166 is referred to as the KEY because it is this data that is used by the input controller processor in making all of its decisions concerning which requests to submit to the request controller 120. In fact, the decision regarding which request is to be sent to the request controller is based on the contents of the IPD field. It is advisable that the KEYs are kept in a high-speed cache of the input control unit 150.

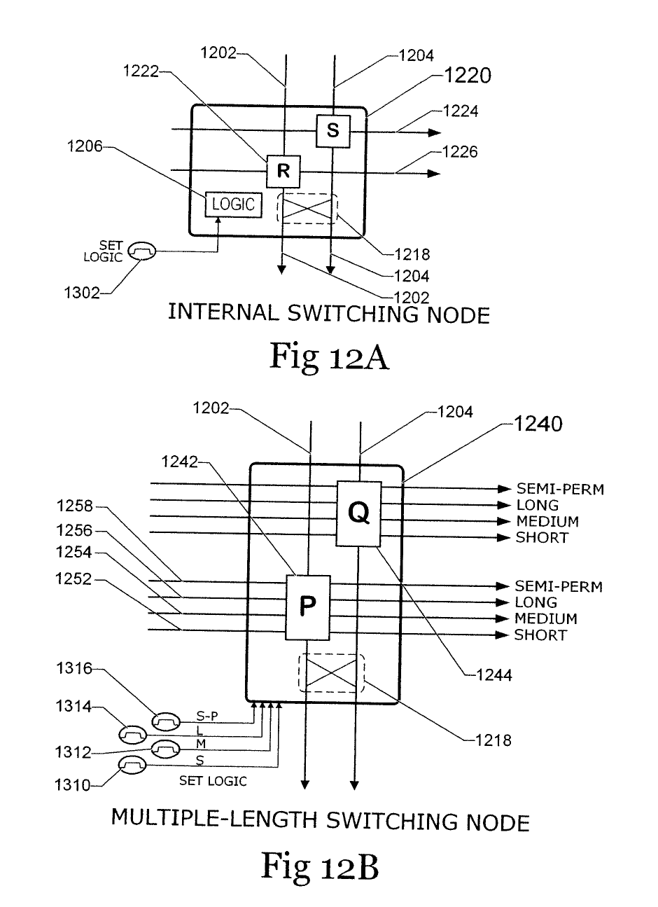

Arriving Internet Protocol (IP) packets and Ethernet frames range widely in length. A segmentation and reassembly (SAR) process is used to break the larger packets and frames into smaller segments for more efficient processing. In preparing and storing the data associated with a packet P in the packet buffer 162, the input controller processor 160 first breaks up PAY field 208 in packet 200 into segments of a predetermined maximum length. In some embodiments, such as those illustrated in FIG. 12A, there is one segment length used in the system. In other embodiments, such as those with nodes as illustrated in FIG. 12B, there is a plurality of segment lengths. The multiple segment length system requires a slightly different data structure than the one illustrated in FIG. 2. One with ordinary skills in the art will be able to make the obvious changes to the data structure to accommodate multiple lengths. Packet data formatted according to FIG. 2C is stored at location PBA 216 in the packet buffer 162. The OPA field 204 contains the address of the target output port of the data switch of the packet P. The NS field 226 indicates the number of segments 232 needed to contain the payload PAY 208 of P.

The KA field 228 indicates the address of the KEY of packet P; the IPA field indicates the input port address. The KA field together with the IPA field forms a unique identifier for packet P. The PAY field is broken into NS segments. In the illustration, the first bits of the PAY field are stored on the top of the stack and the bits immediately following the first segment are stored directly below the first bits; this process continues until the last bits to arrive are stored on the bottom of the stack. Since the payload may not be an integral multiple of the segment length, the bottom entry on the stack may be shorter than the segment length.

Requests packets 240 have the format illustrated in FIG. 2D. Associated with packet P, input controller processor 160 stores request packets in request buffer 164 at request buffer address RBA. Note that RBA 218 is also a field in KEY 210. The BIT field consists of a single bit that is always set to 1 in the presence of data at that buffer location. The output port address that is the target for packet P is stored in the output port address field OPA 204. The request processor data field RPD 246 is information that is to be used by the request processor 106 in the decision of whether or not to allow packet P to be sent to the data switch. The RPD field may contain the QOS field 206 as a sub-field. It may contain other information such as:

how full the buffers are at the input port where the packet P is stored,

information concerning how long the packet P has been stored,

how many segments are in the packet P,

multicast information,

schedule information pertaining to when the input controller can send segments, and

additional information that is helpful for the request processor in making a decision as to whether or not grant permission to the packet P to be sent to the data switch 130.

The fields IPA 230 and KA 228 uniquely identify a packet, and are returned by the request processor in the format of answer packet 250, as illustrated in FIG. 2E.

In FIG. 1A, there are multiple data lines 122 from each input controller IC 150 to request controller 120, and also multiple data lines 116 from each input controller to data switch 130. Notice also that there are multiple data lines 124 from request controller 120 to each input controller, and multiple data lines 118 from the data switch to each output controller 110. In an embodiment where no more than one input port 116 of the data switch has a packet for a given output port 118, data switch DS 130 may be a simple crossbar, and control system 100 of FIG. 1A is capable of controlling it in a scalable manner.

Request to Send at Next Packet Sending Time

At request times T₀, T₁, . . . , Tₘₐₓ, input controller 150 may make requests to send data into switch 130 at a future packet-sending time, T_{msg}. The requests sent at time Tₙ₊₁ are based on recently arriving packets for which no request has yet been made, and on the acceptances and rejections received from the request controller in response to requests sent at times T₀, T₁, . . . , Tₙ. Each input controller ICₙ desiring permission to send packets to the data switch submits a maximum of Rₘₐₓ requests in a time interval beginning at time T₀. Based on responses to these requests, ICₙ submits a maximum of Rₘₐₓ additional requests in a time interval beginning at time T₁. This process is repeated by the input controller until all possible requests have been made or request cycle Tₘₐₓ is completed. At time T_{msg} the input controllers begin sending to the data switch those packets accepted by the request processors. When these packets are sent to the data switch, a new request cycle begins at times T₀+T_{msg}, T₁+T_{msg}, . . . , Tₘₐₓ+T_{msg}.

In this description, n^{th} packet sending cycle begins at the same time as the first round of the (n+1)st request cycle. In other embodiments, the nth packet sending cycle may begins before or after first round of the (n+1)st request cycle.

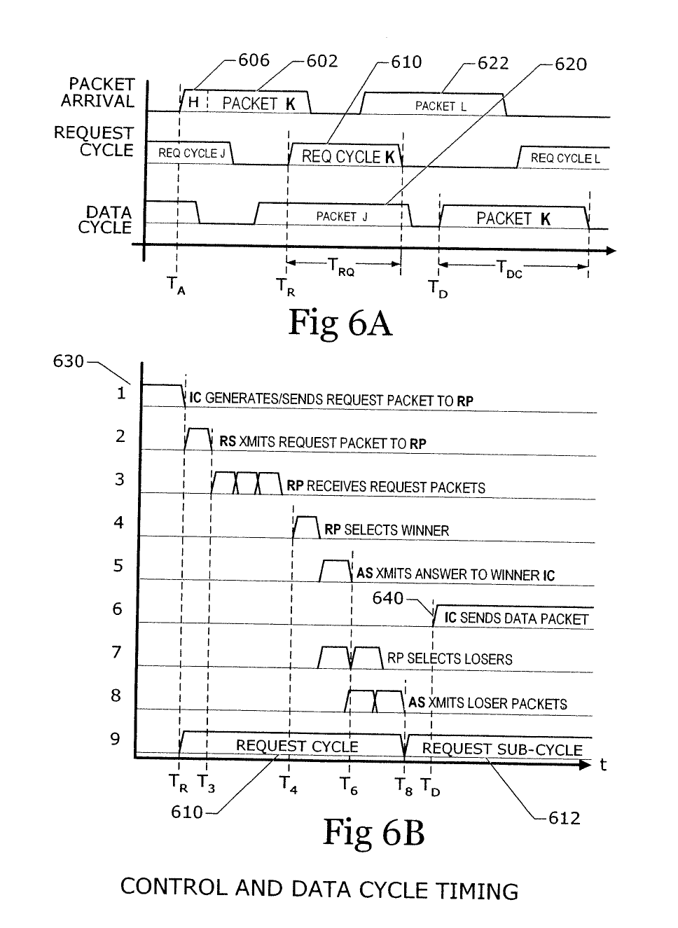

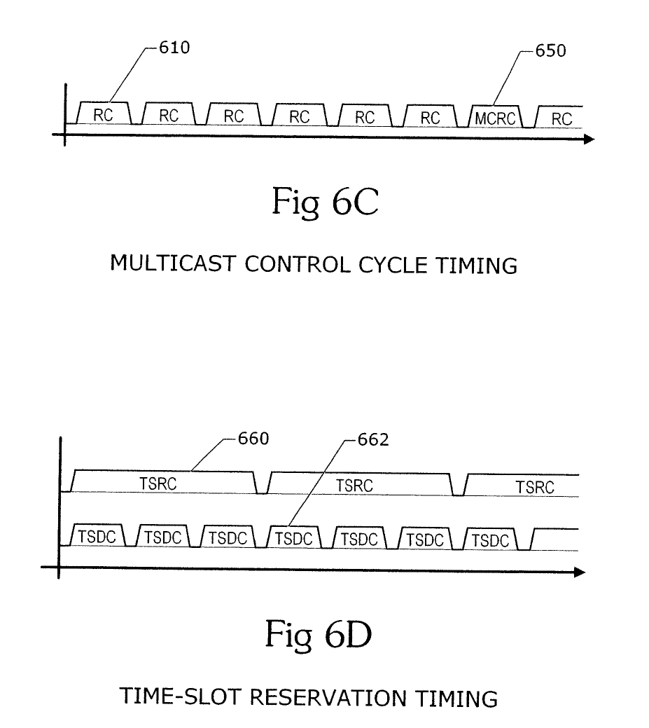

At time T₀, there are a number of input controllers 150 that have one or more packets P in their buffers that are awaiting clearance to be sent through the data switch 130 to an output controller processor 170. Each such input controller processor 160 chooses the packets that it considers most desirable to request to send through the data switch. This decision is based on the IPD values 214 in the KEYs. The number of request packets sent at time T₀ by an input controller processor is limited to a maximum value, Rₘₐₓ. These requests can be made simultaneously or serially, or groups of requests can be sent in a serial fashion. More than J requests can be made into switch of a type taught in Inventions #1, #2 and #3, with J rows on the top level by inserting the requests in different columns (or angles in the nomenclature of Invention #1). Recall that one can simultaneously insert into multiple columns only if multiple packets can fit on a given row. This is feasible in this instance, because the request packets are relatively short. Alternatively, the requests can be simultaneously inserted into a concentrator of the type taught in Invention #4. Another choice is to insert the packets sequentially into a single column (angle) with a second packet directly following a first packet. This is also possible with MLML interconnect networks of these types. In yet another embodiment, the switch RS, and possibly the switches AS and DS, contain a larger number of input ports than there are line cards. It is also desirable in some cases that the number of output columns per row in the request switch is greater than the number of output ports per row in the data switch. Moreover, in case these switches are of a type taught in incorporated patents, the switches can easily contain more rows on their uppermost level than there are line cards. Using one of these techniques, packets are inserted into the request switch in the time period from T₀ to T₀+d₁ (where d₁ is a positive value). The request processors consider all of the requests received from time T₀ to T₀+d₂ (where d₂ is greater than d₁). Answers to these requests are then sent back to the input controllers. Based on these answers, the input controllers can send another round of requests at time T₁ (where T₁ is a time greater than T₀+d₂). The request processors can send an acceptance or a rejection as an answer. It may be the case that some requests sent in the time period from T₀ to T₀+d₁ do not reach the request processor by time T₀+d₂. The request processor does not respond to these requests. This non-response provides information to the input controller because the cause of the non-response is congestion in the request switch. These requests may be submitted at another request sending time Tₙ before time T_{msg} or at another time after T_{msg}. Timing is discussed in more detail in reference to FIGS. 6A and 6B.

The request processors examine all of the requests that they have received. For all or a portion of the requests, the request processors grant permission to the input controllers to send packets associated with the requests to the output controllers. Lower priority requests may be denied entry into the data switch. In addition to the information in the request packet data field RPD, the request processors have information concerning the status of the packet output buffers 172. The request processors can be advised of the status of the packet output buffers by receiving information from those buffers. Alternately, the request processors can keep track of this status by knowledge of what they have put into these buffers and how fast the line cards are able to drain these buffers. In one embodiment, there is one request processor associated with each output controller. In other embodiments, one request processor may be associated with a plurality of output ports. In alternate embodiments a plurality of request processors are located on the same integrated circuit; in yet other embodiments the complete request controller 120 may be located on one or a few integrated circuits, desirably saving space, packaging costs and power. In another embodiment, the entire control system and data switch may be located on a single chip.

The decisions of the request processors can be based on a number of factors, including the following:

the status of the packet output buffers,

a single-value priority field set by input controllers,

the bandwidth from the data switch to the output controllers,

the bandwidth out of the answer switch AS, and

the information in the request processor data field RPD 246 of the request packet.

The request processors have the information that they need to make the proper decisions as to which data to send through the data switch. Consequently, the request processors are able to regulate the flow of data into the data switch and into the output controllers, into the line cards, and finally into output lines 128 to downstream connections. Importantly, once the traffic has left the input controller traffic flows through the data switch fabric without congestion. If any data needs to be discarded, it is low priority data and it is discarded at the input controller, advantageously never entering the switch fabric, where it would cause congestion and could harm the flow of other traffic.

Packets desirably exit system 100 in the same sequence they entered it; no data ever gets out of sequence. When the data packet is sent to the data switch, all of the data is allowed to leave that switch before new data is sent. In this way, segments always arrive at the output controller in sequence. This can be accomplished in a number of ways including:

the request processor is conservative enough in its operation so that it is certain that all of the data passes through the data switch in a fixed amount of time,

the request processor can wait for a signal that all of the data has cleared the data switch before allowing additional data to enter the data switch,

the segment contains a tag field indicating the segment number that is used by the reassembly process,

the data switch is a crossbar switch that directly connects an input controller to an output controller, or

a data switch of the stair-step MLML interconnect type disclosed in Invention #3 can advantageously be used because it uses fewer gates than a crossbar, and when properly controlled, packets can never exit from it out of sequence.

In cases (1) and (2) above, using a switch of a given size with no more than a fixed number N of inserted packets targeted for a given output port, it is possible to predict an upper limit on the time T that packets can remain in that switch. Therefore, the request processors can guarantee that no packets are lost by granting no more than N requests per output port in time unit T.

In the embodiment shown in FIG. 1A, there are multiple lines from the data switch to the output controller. In one embodiment, the request processor can assign a given line to a packet so that all of the segments of that packet enter the output controller on the same line. In this case, the answer from the request processor contains additional information that is used to modify the OPA field in the packet segment header. Additionally, the request processor can grant permission for the input controller to send all of the segments of a given packet without interruption. This has the advantages of:

reducing the workload for the input controller in that a single request is generated and sent for all segments of a data packet,

allowing the input controller to schedule the plurality of segments in one operation and be done with it, and

there are fewer requests for the request processor to handle, allowing more time for it to complete its analysis and generate answer packets,

The assignment of certain output controller input ports requires that additional address bits be used in the header of the data packets. One convenient way to handle the additional address bits is to provide the data switch with additional input ports and additional output ports. The additional output ports are used to put data into the correct bins in the packet output buffers and the additional input ports can be used to handle the additional input lines into the data switch. Alternatively, the additional address bits can be resolved after the packets leave the data switch.

It should be noted that in the case of an embodiment utilizing multiple paths connecting the input and output controllers to the rest of the system, all three switches, RS 104, AS 108, and DS 130, can deliver multiple packets to the same address. Switches with the capability to handle this condition must be used in all three locations. In addition to the obvious advantage of increased bandwidth, this embodiment allows the request processors to make more intelligent decisions since they base their decisions on a larger data set. In a second embodiment, request processors advantageously can send a plurality of urgent packets from one input controller ICₙ with relatively full buffers to a single output controller OCₘ, while refusing requests from other input controllers with less urgent traffic.

Referring also to FIGS. 1B, 1C and 6A, in the operation of system 100 events occur at given time intervals. At time T₀, there are a number of input controller processors 160 that have one or more packets P in their buffers ready to be sent through the data switch 130 to an output control processor 170. Each input controller processor with a packet not yet scheduled to be sent to the data switch chooses one or more packets for which it requests permission to send through the data switch to its destination output port. This decision to grant the request at a given time is generally based on the IPD values 214 in the KEYs. At time T₀, each input controller processor 160 that contains one or more such data packets sends a request packet to the request controller 120 asking permission to send the data packet to the data switch. The request is accepted or denied based of the IPD field of the request packet. The IPD field may consist of or may contain a “priority value”. In case this priority value is a single number, the sole job of the request processors is to compare these numbers. This priority value is a function of the QOS number of the packet. But whereas the QOS number of the packet is fixed in time, the priority value may change in time based on a number of factors including how long a message has been in a buffer in an input port. Request packet 240 associated with the chosen data packet is sent into request controller 120. Each of these requests arrives at the request switch 104 at the same time. The request switch routes packets 240 using their OPA field 204 to the request processor 106 associated with the target output port of the packet. The request processor, RP 106, ranks and generates answer packets 250 that are sent back to the respective input controller through the answer switch 108.

In the general case, several requests may be targeted for the same request processor 106. It is necessary that the request switch 104 can deliver multiple packets to a single target request processor 106. The MLML networks disclosed in the patents incorporated by reference are able to satisfy this requirement. Given this property along with the fact that the MLML networks are self-routing and non-blocking, they are the clear choice for a switch to be used in this application. As the request packets 240 travel through the request switch, the OPA field is removed; the packet arrives at the request processor without this field. The output field is not required at this point because it is implied by the location of the packet. Each request processor examines the data in the RPD field 246 of each request it receives and chooses one or more packets that it allows to be sent to the data switch 130 at prescribed times. A request packet 240 contains the input port address 230 of the input controller that sent the request. The request processors then generate an answer packet 250 for each request, which is sent back to the input processors. By this means, an input controller receives an answer for each granted request. The input controller always honors the answer it received. Alternately stated, if the request is granted, the corresponding data packet is sent into the data switch; if not, the data packet is not sent. The answer packet 250 sent from a request processor to an input controller uses the format given in FIG. 2E. If the request is not granted, the request processor may send negative answers to input controllers. This information may include the busy status of the desired output port and may include information that the input controller can use to estimate the likelihood that a subsequent request will be successful. This information could include the number of other requests sent, their priority, and how busy the output port has been recently. The information could also include a suggested time to resubmit the request.

At time T₁, suppose that an input processor ICₙ that has a packet in its buffer that was neither accepted nor rejected in the T₀ round and suppose moreover that in addition to packets accepted in the T₀ round ICₙ is capable of sending additional data packets at time T_{msg}. Then at time T₁, ICₙ will make requests to send additional packets through the data switch at time T_{msg}. Once again, from among all the requests received, the request processors 106 pick packets that are allowed to be sent.

During the request cycles, the input controller processors 160 use the IPD bits in the KEYs buffer to make their decisions, and the request processors 106 used the RPD bits to make their choice. More about how this is done is given later in this description.

After the request cycles at times T₀, T₁, T₃, . . . Tₘₐₓ, have been completed, each accepted packet is sent to the data switch. Referring to FIG. 2C, when the input controller sends the first segment of the winning packet into the data switch, the top payload segment 232 (the segment with the smallest subscript) is removed from the stack of payload segments. The non-payload fields, 202, 204, 226, 228 and 230 are copied and placed in front of the removed payload segment 232 to form a packet 260 with a format given in FIG. 2F. The input controller processor keeps track of which payload segments have been sent and which segments remain. This can be done by decrementing the NS field 226. When the last segment is sent, all of the data associated with the packet can be removed from the three input controller buffers, 162, 164 and 166. Each input port of the data switch receives either one or no segment packets 260 because no input controller processor sent a second request after the first request was granted. Each output port of the data switch either receives no packets or one packet, because no output controller processor granted more than could be handled by the output ports. When segment packets exit the data switch 130, they are sent to output controllers 110 that reassemble them into a standard format. The reassembled packets are sent to the line cards for downstream transmission.

Since the control system assures that no input port or output port receives multiple data segments, a crossbar switch would be acceptable for use as a data switch. Therefore, this simple embodiment demonstrates an efficient method of managing a large crossbar in an interconnect structure that has bursty traffic and supports quality and type of service. An advantage of a crossbar is that the latency through it is effectively zero after its internal switches have been set. Importantly, an undesirable property of the crossbar is that the number of internal nodes switches grows as N², where N is the number of ports. Using prior art methods it is impossible to generate the N² settings for a large crossbar operating at the high speeds of Internet traffic. Assume that the inputs of a crossbar are represented by rows and output ports by the connecting columns. The control system 120 disclosed above easily generates control settings by a simple translation of the OPA field 204 in the segment packet 260 to a column address, which is supplied at the row where the packet enters the crossbar. One familiar with the art can easily apply this 1-to-N conversion, termed a multiplexer, to the crossbar inputs. When the data packets from the data switch reach the target output controller 110, the output controller processor 170 can begin to reassemble the packet from the segments. This is possible because the NS field 226 gives the number of the received segment and the KA field 228 along with the IPA addresses 230 form a unique packet identifier. Notice that, in case there are N line cards, it may be desirable to build a crossbar that is larger than N×N. In this way there may be multiple inputs 116 and multiple outputs 118. The control system is designed to control this type of larger than minimum size crossbar switch.

While a number of switch fabrics can be used for the data switch, in the preferred embodiment an MLML interconnect network of the type described in the incorporated patents is used for the data switch. This is because:

for N inputs into the data switch, the number of nodes in the switch is of order N·log(N),

multiple inputs can send packets to the same output port and the MLML switch fabric will internally buffer them,

the network is self routing and non-blocking,

the latency is low, and

given that the number of packets sent to a given output is managed by the control system, the maximum time through the system is known.

In one embodiment the request processor 106 can advantageously grant permission for the entire packet consisting of multiple segments to be sent without asking for separate permission for each segment. This scheme has the advantages that the workload of the request processor is reduced and the reassembly of the packet is simpler because it receives all segments without interruption. In fact, in this scheme, the input controller 150 can begin sending segments before the entire packet has arrived from the line card 102. Similarly, the output controller 110 can begin sending the packet to the line card before all of the segments have arrived at the output controller. Therefore, a portion of the packet is sent out of a switch output line before the entire packet has entered the switch input line. In another scheme, separate permission can be requested for each packet segment. An advantage of this scheme is that an urgent packet can cut through a non-urgent packet.

Packet Time-Slot Reservation

Packet time slot reservation is a management technique that is a variant of the packet scheduling method taught in a previous section. At request times T₀, T₁, . . . , Tₘₐₓ, an input controller 150 may make requests to send packets into the data switch beginning at any one of a list of future packet-sending times. The requests sent at time Tₙ₊₁ are based on recently arriving packets for which no request has yet been made, and on the acceptances and rejections received from the request processor in response to requests sent at times T₀, T₁, . . . , Tₙ. Each input controller ICₙ desiring permission to send packets to the data switch submits a maximum of Rₘₐₓ requests in a time interval beginning at time T₀. Based on responses to these requests, ICₙ submits a maximum of Rₘₐₓ additional requests in a time interval beginning at time T₁. This process is repeated by the input controller until all possible requests have been made or request cycle Tₘₐₓ is completed. When the request cycles T₀, T₁, . . . , Tₘₐₓ are all completed the process of making requests begins with request cycles at times T₀+Tₘₐₓ, T₁+Tₘₐₓ . . . , Tₘₐₓ+Tₘₐₓ.

When input controller ICₙ requests to send a packet through the data switch, ICₙ sends a list of times that are available for injecting packet P into the data switch so that all of the segments of the packet can be sent sequentially to the data switch. In case packet P has k segments, ICₙ lists starting times T such that it is possible to inject the segments of the packet at the sequence of times T, T+1, . . . T+k−1. The request processor either approves one of the requested times or rejects them all. As before, all granted requests result in the sending of data. In case all of the times are rejected in the T₀ to T₀+d₁ time interval, then ICₙ may make a request at a later time to send P at any one of a different set of times. When the approved time for sending P arrives, then ICₙ will begin sending the segments of P through the data switch.

This method has the advantage over the method taught in the previous section in that fewer requests are sent through the request switch. The disadvantages are: 1) the request processor must be more complicated in order to process the requests; and 2) there is a significant likelihood that this “all or none” request cannot be approved.

Segment Time-Slot Reservation

Segment time-slot reservation is a management technique that is a variant of the method taught in the previous section. At request times T₀, T₁, . . . , Tₘₐₓ, input controller 150 may make requests to schedule the sending of packets into the data switch. However, this method differs from packet time-slot reservation method in that the message need not be sent with one segment immediately following another. In one embodiment, an input controller provides the request processor with information indicating a plurality of times when it is able to send a packet into the data switch. Each input controller maintains a Time-Slot Available buffer, TSA 168, that indicates when it is scheduled to send segments at future time slots. Referring also to FIG. 6A, each TSA bit represents one time period 620 that a segment can be sent into the data switch, where the first bit of TSA represents the next time period after the current time. In another embodiment, each input controller has one TSA buffer for each path 116 that it has into the data switch.

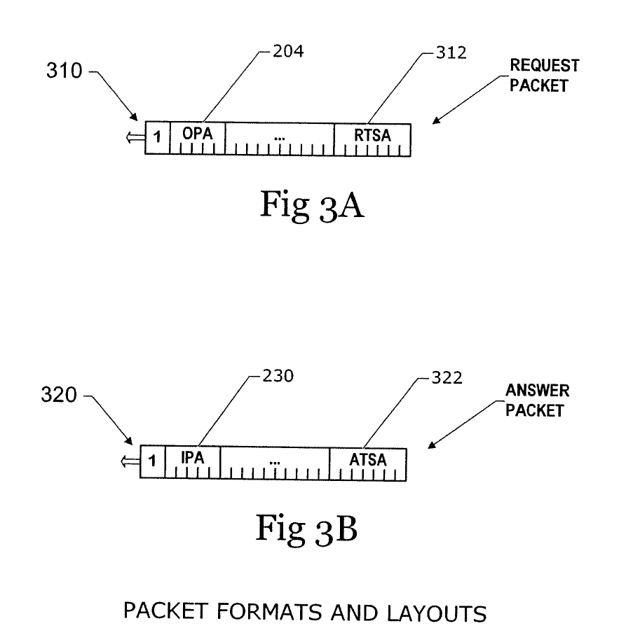

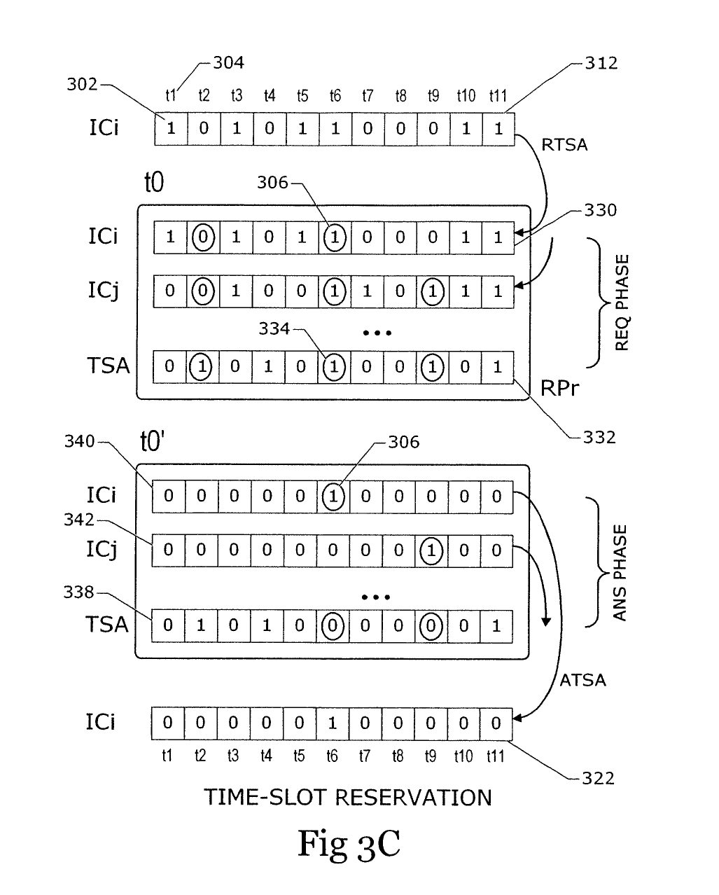

The TSA buffer content is sent to the request processor along with other information including priority. The request processor uses this time-available information to determine when the input controller must send the packet into the data switch. FIGS. 3A and 3B are diagrams of request and answer packets that contain a TSA field. Request packet 310 includes the same fields as request packet 240 and additionally contains a Request Time Slot Available field, RTSA 312. Answer packet 320 includes the same fields as answer packet 250 and additionally contains an answer time slot field, ATSA 322. Each bit of ATSA 322 represents one time period 620 that a packet can be sent into the data switch, where the first bit of ATSA represents the next time period after the current time.

FIG. 3C is a diagram that shows an example of the time-slot reservation processing. Only one segment is considered in the example. A request processor contains TSA buffer 332 that is the availability schedule for the request processor. RTSA buffers 330 are request times received from input controllers. Contents of the buffers are shown at time t0, which is the start of the request processing for the current time period, and time t0′, which is the completion of request processing. At time t0 RPr receives two request packets 310 from two input controllers, ICi and ICj. Each RTSA field contains a set of one-bit subfields 302 representing time periods t1 through t11. The value 1 indicates that the respective input controller can send its packet at the respective time period; the value 0 indicates that it cannot. RTSA request 302 indicates that ICi can send a segment at times t1, t3, t5, t6, t10 and t11. The content of the RTSA field from ICj is also shown. Time-slot available buffer, TSA 332, is maintained in the request processor. The TSA sub-field for time t1 is 0, indicating that the output port is busy at that time. Note that the output port can accept a segment at times t2, t4, t6, t9 and t11.

The request processor examines these buffers in conjunction with priority information in the requests, and determines when each request can be satisfied. Subfields of interest in this discussion are shown circled in FIG. 3C. Time t2 is the earliest time permissible that a packet can be sent in the data switch, as indicated by 1 in TSA 332. Both requests have 0 in subfield t2, therefore, neither of the input controllers can take advantage of it. Similarly, neither input controller can use time t4. Time t6 334 is the earliest time that the output port is available and can also be used by an input controller. Both input controllers can send at time t6 and the request processor selects ICi as the winner based on priority. It generates an Answer Time Slot field 340 that has 1 in subfield 306 at time t6 and o in all other positions. This field is included in the answer packet that is sent back to ICi. The request processor resets subfield t6 334 to 0 in its TSA buffer, which indicates that no other request can be sent at that time. The request processor examines the request from ICj and determines that time t9 is the earliest that the request from ICj can be satisfied. It generates response packet 442 that is sent to ICj, and resets bit t9 to 0 in its TSA buffer.

When ICi receives an answer packet it examines ATSA field 340 to determine when the data segment is to be sent into the data switch. This is time t6 in this example. If it receives all zeros, then the packet cannot be sent during the time duration covered by the subfields. It also updates its buffer by (1) resetting its t6 subfield to 0, and (2) shifting all subfields to the left by one position. The former step means that time t6 is scheduled, and the latter step updates the buffer for use during the next time period, t1. Similarly, each request buffer shifts all subfields to the left by one bit in order to be ready for the requests received at time t1.

Segmentation-and-reassembly (SAR) is advantageously employed in the embodiments taught in the present section. When a long packet arrives it is broken into a large number of segments, the number depending on the length. Request packet 310 includes field NS 226 that indicates the number of segments. The request processor uses this information in conjunction with the TSA information to schedule when the individual segments are sent. Importantly, a single request and answer is used for all segments. Assume that the packet is broken into five segments. The request processor examines the ATSA field along with its own TSA buffer and selects five time periods when the segments are to be sent. In this case ATSA contains five 1's. The five time periods need not be consecutive. This provides a significant additional degree of freedom in the solution for time-slot allocation for packets of different lengths and priorities. Assume on average there are 10 segments per arriving IP or Ethernet packet. A request must therefore be satisfied for every 10 segments sent through the data switch. Accordingly, the request-and-answer cycle can be about 8 or 10 times longer than the data switch cycle, advantageously providing a greater amount of time for the request processor to complete its processing, and permitting a stacked (parallel) data switch fabric to move data segments in bit-parallel fashion.

When urgent traffic is to be accommodated, in one embodiment the request processor reserves certain time periods in the near future for urgent traffic. Assume that traffic consists of high proportion of non-urgent large packets (that are broken into many segments), and a small portion of shorter, but urgent, voice packets. A few large packets could ordinarily occupy an output port for a significant amount of time. In this embodiment, requests pertaining to large packets are not always scheduled for immediate or consecutive transmission, even if there is an immediate slot available. Advantageously, empty slots are always reserved at certain intervals in case urgent traffic arrives. Accordingly, when an urgent packet arrives it is assigned an early time slot that was held open, despite the concurrent transmission of a plurality of long packets through the same output port.

An embodiment using time-slot availability information advantageously reduces the workload of the control system, providing higher overall throughput. Another advantage of this method is that request processors are provided with more information, including time availability information for each of the input processors currently wanting to send to the respective output port. Accordingly, the request processors can make more informed decisions as to which input ports can send at which times, thus balancing priority, urgency, and current traffic conditions in a scalable means of switching-system control.

Over-Requesting Embodiment

In embodiments previously discussed, the input controller submits requests only when it was certain that if the request is accepted it could send a packet. Furthermore, the input controller honors the acceptance by always sending the packet or segment at the permitted time. Thus the request processor knows exactly how much traffic will be sent to the output port. In another embodiment, the input controllers are allowed to submit more requests than they are capable of supplying data packets for. So that when there are N lines 116 from the input controller to the data switch, the input controller can make requests to send M packets through the system even in the case where M is greater than N. In this embodiment, there can be multiple request cycles per data-sending cycle. When an input controller receives a plurality of acceptance notices from the request processors, it chooses to select up to N acceptances that it will honor by sending the corresponding packets or segments. In case there are one or more acceptances than an input controller will honor, then that input controller will inform the request processors which acceptances will be honored and which will not. In the next request cycle, input controllers that received rejections send a second round of requests for packets that were not accepted in the first cycle. The request processors send back a number of acceptances and each request processor can choose additional acceptances that it will act upon. This process continues for a number of request cycles.

After these steps complete, the request processors have permitted no more than the maximum number of packets that can be submitted to the data switch. This embodiment has the advantage that the request processors have more information upon which to make their decisions and therefore, and provided that the request processors employ the proper algorithm, they can give more informed responses. The disadvantage is that the method may require more processing and that the multiple request cycles must be performed in no more than one data-carrying cycle.

System Processor

Referring to FIG. 1D, a system processor 140, is configured to send data to and receive data from the line cards 102, the input controllers 150, output controllers 110, and request processors 106. The system processor communicates with external devices 190 outside of the system, such as an administration and management system. A few I/O ports 142 and 144 of the data switch, and a few I/O ports 146 and 148 of the control system, are reserved for use by the system processor. The system processor can use the data received from input controllers 150 and from request processors 106 to inform a global management system of local conditions and to respond to the requests of the global management system. Input controllers and output controllers are connected by path 152 that is a means for them to communicate with other. Additionally, connection 152 allows the system processor to send a packet to a given input controller 150 by sending it through the data switch to the connected output controller. The latter forwards the packet to the connected input controller. Similarly, connection 152 allows an output controller to send a packet to the system processor by first sending it through the connected input controller. The system processor can send packets to the control system 120 by means of I/O connections 146. The system processor receives packets from the control system by means of connections 148. Accordingly, the system processor 140 has transmit and receive capabilities with respect to each request processor 106, input controller 150, and output controller 110. Some uses of this communication capability include receiving status information and from the input and output controllers and the request processors, and transmitting setup and operational commands and parameters to them in a dynamic fashion.

Combined Request Switch and Data Switch

In the embodiment illustrated in FIG. 1E, there is a single device RP/OC_{N} 154 that performs the functions of both a request processor RP_{N} 106 and an output controller OC_{N} 110. Also, there is a single switch RS/DS 156 that performs the functions of both the request switch RS 104 and the data switch DS 130. The line cards 102 accept the data packets and perform functions already described in this document. The input controllers 150 may parse and decompose the packet into a plurality of segments and also perform other functions already described in this document. The input controllers then request permission to inject the packet or segments into the data switch.

In a first embodiment, the request packet is of the form illustrated in FIG. 2D. These request packets are injected into RS/DS switch 156. In one scheme, these request packets are injected into the RS/DS switch at the same time as the data packets. In another scheme, these packets are injected at special request-packet-injection times. Since the request packets are generally shorter than data packets, the multiple-length-packet switch embodiment of a previous section can be advantageously used for this purpose.

In a second embodiment, the request packet is also a segment packet as illustrated in FIG. 2F. The input controller sends the first segment, S₀, of a packet through the RS/DS switch. When S₀ arrives at the request processor section of RP/OC_{N}, the request processor decides whether to allow the sending of the rest of the segments of the packet, and if the rest of the segments are allowed, the request processor schedules the sending of those segments. These decisions are made in much the same fashion as they were made by the request processors in FIG. 1A. The answers to these decisions are sent to the input controllers through the answer switch AS. In one scheme, the request processor sends an answer only when it receives the first segment of a packet. In another scheme, the request processor sends an answer to each request. In one embodiment, the answer contains the minimum length of the time interval that the request processor must wait before sending another segment of the same packet. The number of lines 160 into RP/OC_{N} 154 is usually greater than the number of segments that are given permission to enter the RP/OC_{N}. In this way, the segments that have been scheduled to exit the RS/DS switch are able to pass through the RS/DS switch into the output controllers, while the segments that are also requests have a path into RP/OC_{N} as well. In case the number of request segments plus the number of scheduled segments exceeds the number of lines 160 from RS/DS switch 156 into output controller 154, then the excess packets are buffered internally in switch RS/DS 156 and can enter the target RP/OC at the next cycle.

In case a packet is not able to exit the switch immediately because all of the output lines are blocked, there is a procedure to keep the segments of a data packet from getting out of order. This procedure also keeps the RS/DS from becoming overloaded. For a packet segment S_{M} traveling from an input controller IC_{P} to an output controller section of RP/OC_{K}, the following procedure is followed. When the packet segment S_{M} enters RP/OC_{K}, then RP/OC_{K} sends an acknowledgement packet (not illustrated) through answer switch AS 108 to IC_{P} 150. Only after IC_{P} has received the acknowledgement packet will it send the next segment, S_{M+1}. Since the answer switch only sends acknowledgements for packet segments that successfully pass through the RS/DS switch into an output controller, the segments of a packet cannot get out of sequence. An alternate scheme is to include a segment number field in the segment packet, which the output controller uses to properly assemble the segments into a valid packet for transmission downstream.

The acknowledgement from RP/OC_{K} to IC_{P} is sent in the form of an answer packet illustrated in FIG. 2E. Since the payload of this packet is short relative to the length of the segment packet, the system can be designed so that an input controller sending the segment S_{M} to RP/OC_{K} will typically receive an answer before it has finished inserting the entire segment S_{M} into switch RS/DS. In this way, in case the answer is affirmative, the input port processor can advantageously begin the transmission of segment S_{M+1} immediately following the transmission of segment S_{M}.

An input controller receives no more than one answer for each request it makes. Therefore, the number of answers per unit time received by an input controller is not greater than the number of requests per unit time sent from the same input controller. Advantageously, an answer switch employing this procedure cannot become overloaded since all answers sent to a given input controller are in response to requests previously sent by that controller.

Referring to FIG. 1A, in an alternate embodiment not illustrated, request switch 104 and answer switch 108 are implemented as a single component, which handles both requests and answers. These two functions are performed by a single MLML switch fabric alternately handling requests and answers in a time-sharing fashion. This switch carries out the function of request switch 104 at one time, and the function of answer switch 108 at the next. An MLML switch fabric that is suitable for implementing request switch 104 is generally suitable for the combined function discussed here. The function of request processor 106 is handled by an RP/OC processor 154, such as those described for FIGS. 1E and 1F. The operation of the system in this embodiment is logically equivalent to the controlled switch system 100. This embodiment advantageously reduces the amount of circuitry needed to implement control system 120.

Single Switch Embodiment

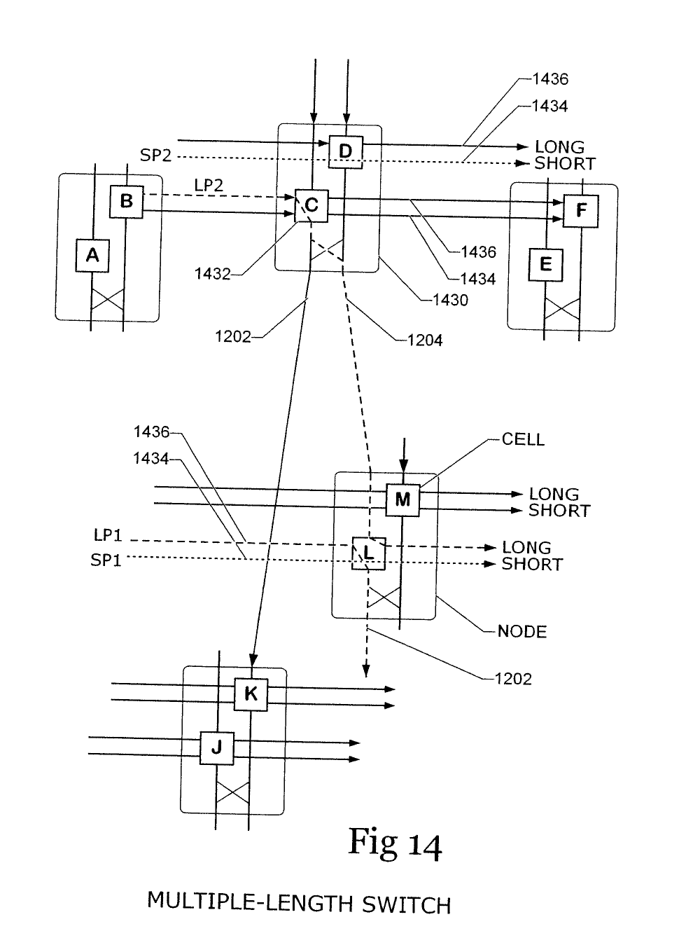

FIG. 1F illustrates an embodiment of the invention wherein switch RADS 158 carries and switches all of the packets for the request switch, the answer switch and the data switch. In this embodiment, it is useful to use the multiple-length-packet switch described later for FIGS. 12B and 14. The operation of the system in this embodiment is logically equivalent to the combined data switch and request switch embodiment described for FIG. 1E. This embodiment advantageously reduces the amount of circuitry needed to implement control system 120 and data switch system 130.

The control systems discussed above can employ two types of flow control schemes. The first scheme is a request-answer method, where data is sent by input controller 150 only after an affirmative answer is received from request processor 106, or RP/OC processor 154. This method can also be used with the systems illustrated in FIGS. 1A and 1E. In these systems, a specific request packet is generated and transmitted to the request processor, which generates an answer and sends it back to the input controller. The input controller always waits until it receives an affirmative answer from the RP/OC processor before sending the next segment or remaining segments. In the system illustrated in FIG. 1E the first data segment can be treated as a combined request packet and data segment, where the request pertains to the next segment, or to all the remaining segments.

The second scheme is a “send-until-stopped” method where the input controller sends data segments continuously unless the RP/OC processor sends a halt-transmission or pause-transmission packet back to the input controller. A distinct request packet is not used as the segment itself implies a request. This method can be used with the systems illustrated in FIGS. 1E and 1F. If the input controller does not receive a halt or pause signal, it continues transmitting segments and packets. Otherwise, upon receiving a halt signal it waits until it receives a resume-transmission packet from the RP/OC processor; or upon receiving a pause signal it waits for the number of time periods indicated in the pause-transmission packet and then resumes transmission. In this manner traffic moves promptly from input to output, and impending congestion at an output is immediately regulated, desirably preventing an overload condition at the output port. This “send-until-stopped” embodiment is especially suitable for an Ethernet switch.

A massively parallel computer could be constructed so that the processors could communicate via a large single-switch network. One skilled in the art could use the techniques of the present invention to construct a software program in which the computer network served as a request switch, an answer switch and a data switch. In this way, the techniques described in this patent can be employed in software.

In this single switch embodiment as well as in other embodiments, there are a number of answers possible. When a request to send a packet is received, the answers include but are not limited to: 1) send the present segment and continue sending segments until the entire packet has been sent; 2) send the present segment but make a request later to send additional segments; 3) at some unspecified time in the future, re-submit a request to send the present segment; 4) at a prescribed time in the future, resubmit a request to send the present packet; 5) discard the present segment; 6) send the present segment now and send the next segment at a prescribed time in the future. One of ordinary skill in the art will find other answers that fit various system requirements.

Multicasting Using Large MLML Switches

Multicasting refers to the sending of a packet from one input port to a plural number of output ports. In many of the electronic embodiments of the switches disclosed in the present patent and in the patents incorporated by reference, the logic at a node is very simple, not requiring many gates. Minimal chip real estate is used for logic as compared to the amount of I/O connections available. Consequently, the size of the switch is limited by the number of pins on the chip rather than the amount of logic. Accordingly, there is ample room to put a large number of nodes on a chip. Since the lines 122 carrying data from the request processors to the request switch are on the chip, the bandwidth across these lines can be much greater than the bandwidth through the lines 134 into the input pins of the chip. Moreover, it is possible to make the request switch large enough to handle this bandwidth. In a system where the number of rows in the top level of the MLML network is N times the number of input controllers, it is possible to multicast a single packet to as many as N output controllers. Multicasting to K output controllers (where K.ltoreq.N) can be accomplished by having the input controllers first submit K requests to the request processor, with each submitted request having a separate output port address. The request processor then returns L approvals (L.ltoreq.K) to the input controller. The input controller then sends L separate packets through the data switch with the L packets each having the same payload but a different output port address. In order to multicast to more than N outputs, it is necessary to repeat the above cycle a sufficient number of times. In order to accomplish this type of multicasting, the input controllers must have access to stored multicast address sets. The necessary changes to the basic system necessary to implement this type of multicasting will be obvious to one skilled in the art.

Special Multicasting Hardware

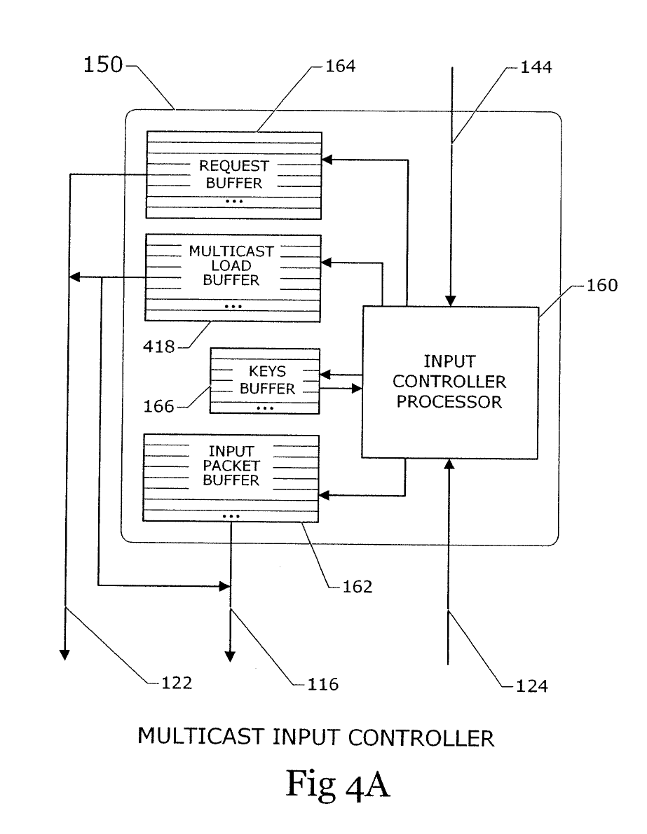

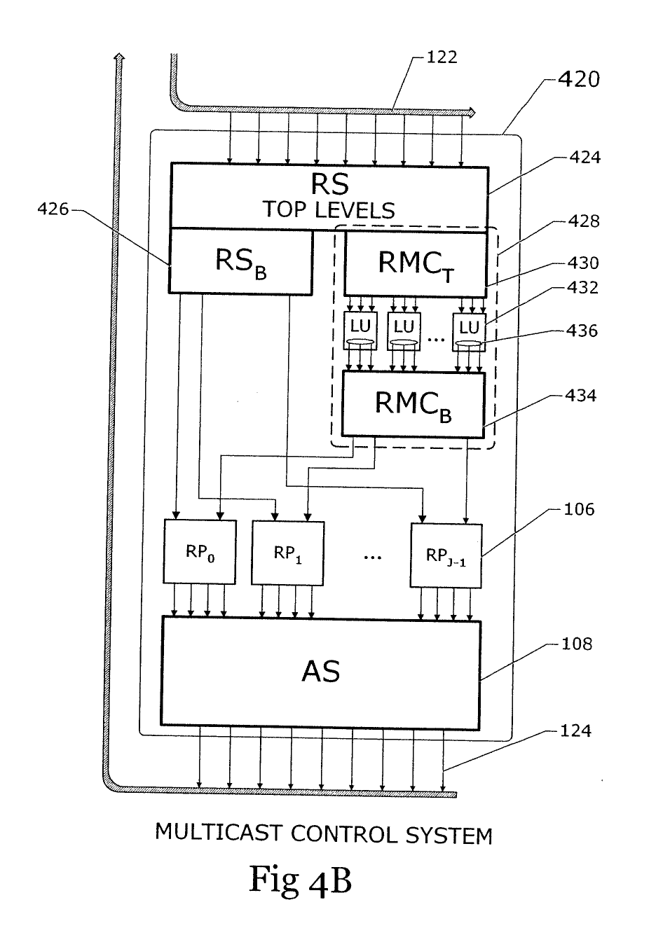

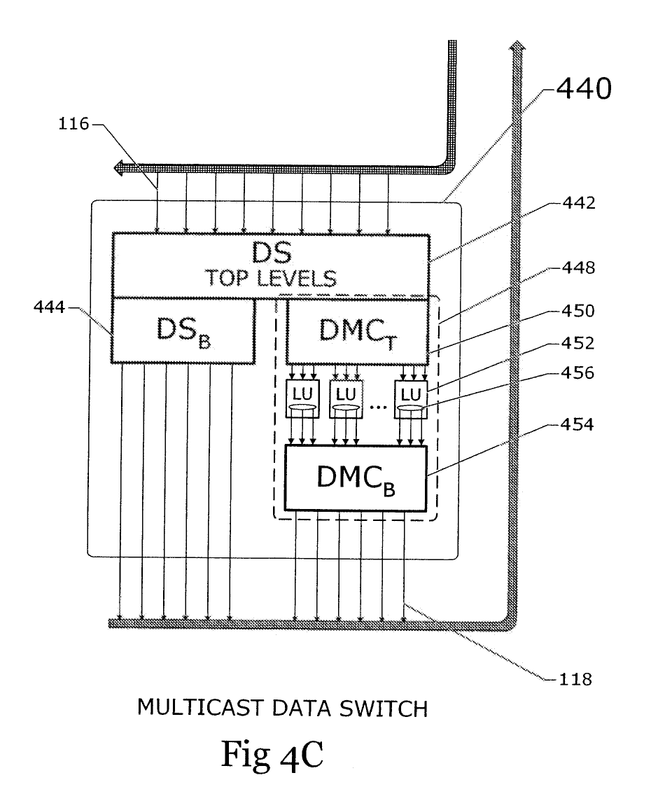

FIGS. 4A, 4B and 4C show another embodiment of system 100 that supports multicasting. Request controller 120 shown in FIG. 1A has been replaced with multicasting request controller 420, and data switch 130 has been replaced with multicasting data switch 440. The multicasting techniques employed here are based on those taught in Invention #5. A multicast packet is sent to a plurality of output ports, that taken together form a multicast set. There is a fixed upper limit on the number of members in the multicast set. If the limit is L and if there are more than L members in the actual set, then a plurality of multicast sets is used. An output port may be a member of more than one multicast set.

Multicast SEND requests are accomplished via indirect addressing. Logic units LU come in pairs, 432 and 452, one in the request controller 420 and one in the data switch 440. Each pair of logic units share a unique logical output port address OPA 204, which is distinct from any physical output port address. The logical address represents a plural number of physical output addresses. Each logic unit of the pair contains a storage ring, and each of these storage rings is loaded with an identical set of physical output port addresses. The storage ring contains the list of addresses, in effect forming a table of addresses where the table is referenced by its special address. By employing this tabular output-port address scheme, multicast switches, RMC_{T} 430 and DMC_{T} 450, efficiently process all multicast requests. Request packets and data packets are replicated by the logic units 432 and 452, in concert with their respective storage rings 436 and 456. Accordingly, a single request packet sent to a multicast address is received by the appropriate logic unit 432 or 452, which in turn, replicates the packet once for each item in the table contained in its storage ring. Each replicated packet has a new output address taken from the table, and is forwarded to a request processor 106 or output controller 110. Non-multicast requests never enter the multicast switches RMC_{T} 430, but are instead directed to bottom levels of switch RS_{B} 426. Similarly, non-multicast data packets never enter the multicast data switches DMC_{T} 450, but are instead directed to bottom levels of switch DS_{B} 444.

FIGS. 2G, 2H, 2I, 2J, 2K and 2L show additional packet and field modifications for supporting multicasting. Table 2 is an overview of the contents of these fields.

TABLE 2

| | |
|---|---|
| MAM | A bitmask indicating approval for a single address requested by a multicast send |
| | packet. |
| MF | A one-bit field that indicates a multicast packet. |
| MLC | A two-bit field that tracks the status of the two LOADs needed to update a set of |
| | multicast addresses in storage rings 436 and 456. |
| MLF | A one-bit field indicating that a packet wants to update a set of multicast |
| | addresses stored in the switches. |
| MRM | A bitmask that keeps track of pending approvals needed to complete a multicast |
| | SEND request. |
| MSM | A bitmask that that keeps track of approvals for a multicast SEND request which |
| | have not yet been processed by the multicast data switch. |
| PLBA | Address in the multicast LOAD buffer where LOAD packets are stored. Used |
| | instead of the packet buffer address PBA when a multicast load is requested. |

Loading Multicast Address Sets

Loading of storage rings 436 and 456 is accomplished using a multicast packet 205, given in FIG. 2G, whose format is based on that of the packet 200. A system processor 140 generates the LOAD requests. When the packet arrives at an input controller IC 150, the input controller processor 160 examines the output port address OPA 204 and notes by the address that that a multicast packet has arrived. If the multicast load flag MLF 203 is on, the packet is a multicast load and the set of addresses to be loaded resides in the PAY field 208. In one embodiment, the logical output port address that is given has been previously supplied to the requester. In other embodiments, the logical output port address is a dummy address that triggers the controller to select the logical output port address for a pair of available logic units; this OPA will be returned to the requester for use when sending the corresponding multicast data packets. In either case, the input controller processor then generates and stores a packet entry 225 in its multicast load buffer 418 and creates a multicast buffer KEY entry 215 in its KEYs buffer 166. The buffer KEY 215 contains a two-bit multicast load counter MLC 213 that is turned on to indicate that a LOAD request is ready for processing. The multicast load buffer address PLBA 211 contains the address in the multicast load buffer where the multicast load packet is stored. During a request cycle, the input controller processor sends the multicast load packet to the request controller 420 to load the storage ring in the logic unit at address OPA 204, and then turns off the first bit of MLC 213 to indicate that this LOAD has been done. Similarly, the input controller processor selects a data cycle in which it sends the same multicast load packet to the data controller 440, and the second bit of MLC 213 is turned off. When both bits of MLC 213 have been turned off, the input controller processor can remove all information for this request from its KEYs buffer and multicast load buffer since its part in the load request has been completed. Processing of the multicast load packet is the same at both the request controller 420 and the data controller 440. Each controller uses the output port address to send the packet through its MC_{T} switch to its appropriate logic unit LU 432 or LU 452. Since the multicast load flag MLF 203 is on, each logic unit notes that it has been asked to update the addresses in its storage ring by using the information in the packet payload PAY 208. This update method synchronizes the sets of addresses in corresponding storage ring pairs.

Multicasting Data Packets

Multicast packets are distinguished from non-multicast packets by their output port addresses OPA 204. Multicast packets not having the multicast load flag MLF 203 turned on are called multicast send packets. When the input controller processor 160 receives a packet 205 and determines from the output port address and multicast load flag that it is a multicast send packet, the processor makes the appropriate entries in its packet input buffer 162, request buffer 164 and KEYs buffer 166. Two special fields in the multicast buffer KEY 215 are used for SEND requests. The multicast request mask MRM 217 keeps track of which addresses are to be selected from those in the target storage ring. This mask is initially set to select all addresses in the ring (all ones). The multicast send mask MSM 219 keeps track of which requested addresses have been approved by the request processors, RP 106. This mask is initially set to all zeros, indicating that no approvals have yet been given.

When the input controller processor examines its KEYs buffer and selects a multicast send entry to submit to the request controller 420, the buffer key's current multicast request mask is copied into the request packet 245 and the resulting packet is sent to the request processor. The request switch RS 424 uses the output port address to send the packet to the multicast switch RMC_{T}, which routes the packet on to the logic unit LU 432 designated by OPA 204. The logic unit determines from MLF 203 that it is not a load request, and uses the multicast request mask MRM 217 to decide which of the addresses in its storage ring to use in multicasting. For each selected address, the logic unit duplicates the request packet 245 making the following changes. First, the logical output port address OPA 204 is replaced with a physical port address from selected ring data. Second, the multicast flag MLF 203 is turned on so that that the request processors know that this is a multicast packet. Third, the multicast request mask is replaced by a multicast answer mask MAM 251, which identifies the position of the address from the storage ring that was loaded into the output port address. For example, the packet created for the third address in the storage ring has the value 1 in the third mask bit and zeros elsewhere. The logic unit sends each of the generated packets to the switch RMC_{B} that uses the physical output port address to send the packet to the appropriate request processor, RP 106.

Each request processor examines its set of request packets and decides which ones to approve and then generates a multicast answer packet 255 for each approval. For multicast approvals, the request processor includes the multicast answer mask MAM 251. The request processor sends these answer packets to the answer switch AS 108, which uses IPA 230 to route each packet back to its originating input control unit. The input controller processor uses the answer packet to update buffer KEY data. For multicast SEND requests this includes adding the output port approved in the multicast answer mask to the multicast send mask and removing it from the multicast request mask. Thus, the multicast request mask keeps track of addresses that have not yet received approval, and the multicast send mask keeps track of those that have been approved and are ready to send to the data controller 440.

During the SEND cycle, approved multicast packets are sent to the data controller as multicast segment packets 265 that include the multicast send mask MSM 219. The output port address is used by the data switches DS 442 and MC_{T} 430 to route the packet to the designated logic unit. The logic unit creates a set of multicast segment packets, each identical to the original packet, but having a physical output port address supplied by the logic unit according to the information on the multicast send mask. The modified multicast segment packets then pass through the multicast switch MC_{B}, which sends them to the proper output controller 110.

The output controller processor 170 reassembles the segment packets by using the packet identifiers, KA 228 and IPA 230, and the NS 226 field. Reassembled segment packets are placed in the packet output buffer 172 for sending to LC 102, thus completing the SEND cycle. Non-multicasting packets are processed in a similar manner, except that they bypass the multicast switch 448. Instead, the data switch 442 routes the packet through switch DS 444 based on the packet's physical output port address OPA 204.

Multicast Bus Switch

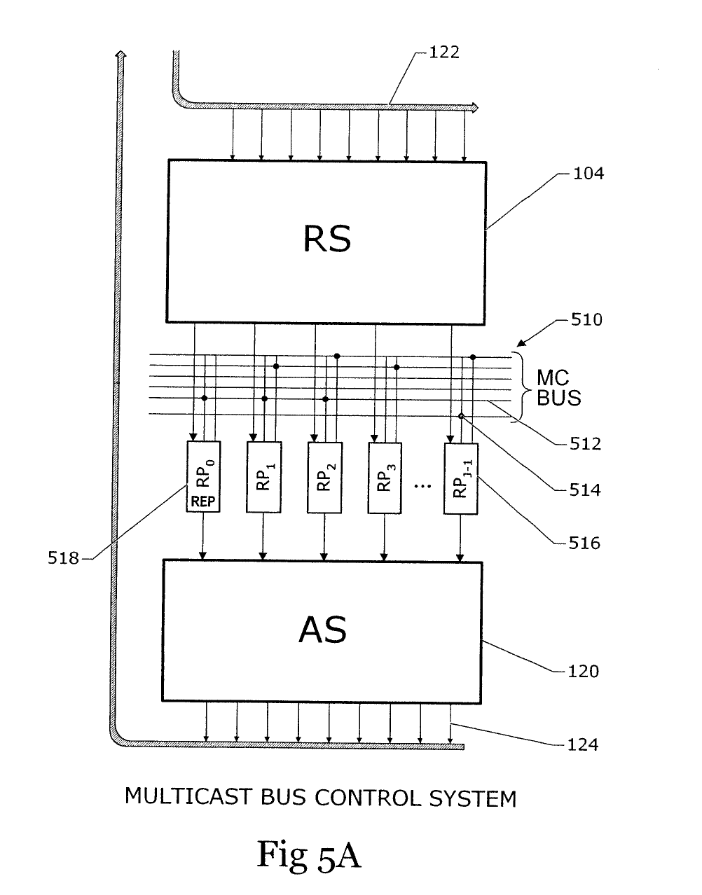

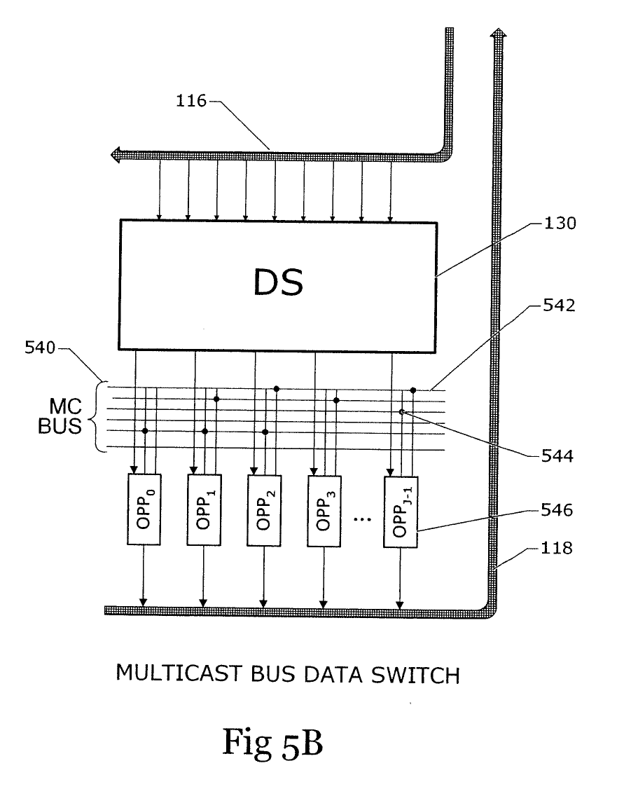

FIGS. 5A and 5B are diagrams showing an alternate method for implementing and supporting multicasting using an on-chip bus structure. FIG. 5A is a diagram showing a plurality of request processors 516 interconnected by means of a multicast request bus switch 510. FIG. 5B is a diagram showing a plurality of output processors 546 interconnected by means of a data-packet-carrying multicast bus switch 540.

A multicast packet is sent to a plurality of output ports, which taken together form a multicast set. Bus 510 allows connections to be sent to specific request processors. The multicast bus functions like an M-by-N crossbar switch, where M and N need not be equal, and where the links, 514 and 544. One connector 512 in the bus represents one multicast set. Each request processor has the capability of forming an I/O link 514 with zero or more connectors 512. These links are set up prior to the use of the buses. A given request processor 516 only links to connectors 512 that represent the multicast set or sets to which it belongs, and is not connected to other connectors in the bus. The output port processors 546 are similarly linked to zero or more data-carrying connectors 542 of output multicast bus 540. Those output port processors that are members of the same set have an I/O link 544 to a connector 542 on the bus representing that set. These connection links, 514 and 544, are dynamically configurable. Accordingly, special MC LOAD messages add, change and remove output ports as members of a given multicast set.

One request processor is specified as the representative (REP processor) of a given multicast set. An input port processor sends a multicast request only to the REP processor 518 of the set. FIG. 6C illustrates a multicast timing scheme where multicast requests are made only at designated time periods, MCRC 650. If an input controller 150 has one or more multicast request in its buffer, it waits for a multicast request cycle 650 to send its requests to a REP processor. A REP processor that receives a multicast request informs the other members of the set by sending a signal on the shared bus connector b. This signal is received by all other request processors linked to the connector. If a REP processor receives two or more multicast requests at the same time, it uses priority information in the requests to decide which requests are placed on the bus.

After the REP processor has selected one or more requests to put on the bus, it uses connector 512 to interrogate other member of the set before sending an answer packet back to the winning input controller. A request processor may be a member of one or more multicast sets, and may receive notification of two or more multicast requests at one time. Alternately stated, a request processor that is a member of more than one multicast set may detect that a plurality of multicast bus connections 514 are active at one time. In such a case, it may accept one or more requests. Each request processor uses the same bus connector to inform the REP processor that it will accept (or refuse) the request. This information is transmitted over connector 512 from each request processor to the REP processor by using a time-sharing scheme. Each request processor has a particular time slot when it signals its acceptance or refusal. Accordingly, the REP processor receives responses from all members in bit-serial fashion, one bit per member of the set. In an alternate embodiment, non-REP processors inform the REP processor ahead of time that they will be busy.

The REP processor then builds a multicast bit-mask that indicates which members of the multicast set accept the request; the value 1 indicates acceptance, the value 0 indicates refusal, and the position in the bitmask indicates which member. The reply from the REP processor to the input controller includes this bitmask and is sent to the requesting input controller by means of the answer switch. The REP processor also sends a rejection answer packet back to an input controller in case the bit-mask contains all zeros. A denied multicast request may be reattempted at a subsequent multicast cycle. In an alternative embodiment, each output port keeps a special buffer area for each multicast set for which it is a member. At a prescribed time, an output port sends a status to each of the REP processors corresponding to its multicast sets. This process continues during data sending cycles. In this fashion, the Rep knows in advance which output ports are able to receive multicast packets and therefore is able to respond to multicast requests immediately without sending requests to all of its members.

During the multicast data cycle, an input controller with an acceptance multicast response inserts the multicast bitmask into the data packet header. The input controller then sends the data packet to the output port processor that represents the multicast set at the output. Recall that the output port processors are connected to multicast output bus 540, analogous to the means whereby request processors are connected to multicast bus 510. The output port processor REP that receives the packet header transmits the multicast bitmask on the output bus connector. An output port processor looks for 0 or 1 at a time corresponding to its position in the set. If 1 is detected, then that output port processor is selected for output. After transmitting the multicast bitmask, the REP output port processor immediately places the data packet on the same connector. The selected output port processors simply copy the payload to the output connection, desirably accomplishing the multicast operation. In alternate embodiments, a single bus connector, 512 and 542, that represents a given multicast set may be implemented by a plurality of connectors, desirably reducing the amount of time it takes to transmit the bit-mask. In another embodiment, where the multicast packet is sent only in case all of the outputs on a bus can accept a packet, a 0 indicates an acceptance and a 1 indicates a rejection. All processors respond at the same time and if a single one is received, then the request is denied.

A request processor that receives two or more multicast requests may accept one or more requests, which are indicated by 1 in the bitmask received back by the requesting input controller. A request processor that rejects a request is indicated by 0 in the bit-mask. If an input controller does not get all 1's (indicating 100% acceptance) for all members of the set then it can make another attempt at a subsequent multicast cycle. In this case, the request has a bitmask in the header that is used to indicate which members of the set should respond to or ignore the request. In one embodiment, multicast packets are always sent from the output processor immediately when they are received. In another embodiment, the output port can treat the multicast packets just like other packets and can be stored in the output port buffer to be sent at a later time.

An overload condition can potentially occur when upstream devices frequently send multicast packets, or when two or more upstream sources send a lot of traffic to one output port. Recall that all packets that exit an output port of the data switch must have been approved by the respective request processor. If a given request processor receives too many requests, whether as a result of multicast requests or because many input sources want to send to the output port or otherwise, the request processor accepts only as many as can be sent through the output port. Accordingly, an overload at an output port cannot occur when using the control system disclosed here.

Referring also to FIG. 1D an input controller that is denied permission to send packets through the data switch can try later. Importantly, it can discard packets in its buffer when an impending overload occurs. The input controller has sufficient information about which packets are not being accepted for which output ports such that it may evaluate the situation and determine the type and cause of the overload. It can then inform the system processor 140 of this situation by sending it a packet through the data switch. Recall that the system processor has a plurality of I/O connections to the control system 120 and to the data switch 130. The system processor can process packets from one or more input controllers at one time. System processor 140 can then generate and send appropriate packets to upstream devices to inform them of the overload condition so that the problem may be fixed at the source. The system processor can also inform a given input port processor to ignore and discard certain packets that it may have in its buffer and may receive in the future. Importantly, the scalable switching system disclosed here is immune to overloading, regardless of cause, and is therefore regarded as congestion-free.

The multicast packets can be sent through the data switch at a special time or at the same time with other data. In one embodiment, a special bit informs a REP output port processor that the packet is to be multicast to all of the members of the bus or to those members in some bit-mask. In the later case, a special set up cycle sets the switches to the members selected by the bit-mask. In another embodiment, packets are sent through the special multicast hardware only if all members of the bus are to receive the packet. It is possible that the number of multicast sets is greater than the number of output ports. In other embodiments, there are a plural number of multicast sets with each output port being a member of only one multicast set. Three methods of multicasting have been presented. They include:

1. the type of multicasting that requires no special hardware in which a single packet arriving into the input controller causes a plurality of requests to be sent to the request switch and a plurality of packets to be sent to the data switch,

2. a type of multicasting using the rotating FIFO structure taught in Invention #5, and

3. a type of multicasting requiring a multicast bus.

A given system using multicasting can employ one, two, or all three of these schemes.

System Timing

Referring to FIG. 1A, an arriving packet enters system 100 through input line 126 on line card 102. The line card parses the packet header and other fields to determine where to send it and to determine priority and quality of service. This information, along with the packet, is sent over path 134 to connected input controller 150. The input controller uses this information to generate a request packet 240 that it sends into control system 120. In the control system, request switch 104 transmits the request packet to a request processor 106 that controls all traffic sent to a given output port. In the general case, one request processor 106 represents one output port 110, and controls all traffic such that no packet is ever sent to a system output port 128 without having been approved by the corresponding request processor. In some embodiments the request processor 106 is physically connected to the output controller 110, as shown in FIGS. 1E and 1F. The request processor receives the packet; it may receive requests from other input controllers that also have data packets wanting to be sent to the same output port. The request processor ranks the requests based on priority information in each packet and may accept one or more requests while denying other requests. It immediately generates one or more answer packets 250 that are sent through answer switch 108 to inform the input controllers of accepted “winning” and rejected “loosing” packets. An input controller with an accepted data packet sends the data packet into data switch 130 that transmits it to an output controller 110. The output controller removes any internally used fields and sends it to the line card over path 132. The line card converts the packet into a format suitable for physical transmission downstream 128. A request processor that rejects one or more requests additionally may send answer packets indicating rejections to input controllers to provide them with information that they use to estimate the likelihood of acceptance of the packet at a later cycle.

Referring also to FIG. 6A, the timing of request and answer processing is overlapped with transmission of data packets through the data switch, which is also overlapped with packet reception and parsing performed by the line card in conjunction with the input controller. An arriving packet K 602 is first processed by the line card that examines the header and other relevant packet fields 606 to determine the packet's output port address 204 and QOS information. A new packet arrives at time T_{A} at the line card. At time T_{R} the line card has received and processed sufficient packet information such that the input controller can begin its request cycle. The input controller generates request packet 240. Time period T_{RQ} 610 is the time that the system uses to generate and process requests, and to receive and answer at the winning input controller. Time period T_{DC} 620 is the amount of time that the data switch 130 uses to transmit a packet from its input port 116 to output port 118. In one embodiment, T_{DC} is a longer period than T_{RQ}.

In the example illustrated in FIG. 6A, a packet K 602 is received by the line card at time T_{A}. The input controller generates request packet 240 that is handled by the control system during time period T_{RQ}. During this time period a previously arriving packet J 620 moves through the data switch. Also during time period T_{RQ}, another packet L 622 is arriving at the line card. Importantly, because a request processor sees all requests for its output port and accepts no more than could cause congestion, the data switch is never overloaded or congested. Input controllers are provided with necessary and sufficient information to determine what to do next with packets in its buffers. Packets that must be discarded are equitably chosen based on all relevant information in their header. Request switch 104, answer switch 108, and data switch 130 are scalable, wormholing MLML interconnects of the types taught in Inventions #1, #2 and #3. Accordingly, requests are processed in overlapped fashion with data packet switching, such that scalable, global control of the system is advantageously performed in a manner that permits data packets to move through system without delay.

FIG. 6B is a timing diagram that shows in more detail the steps of overlapped processing of an embodiment that also supports multiple, request sub-cycles. The following list refers to numbered lines 630 of the diagram:

1. The input controller, IC 150, has received sufficient information from the line card to construct a request packet 240. The input controller may have other packets in its input buffer and may select one or more of them as its top priority requests. Sending the first request packet or packets into the request switch at time T_{R} marks the beginning of the request cycle. After time T_{R}, if there is at least one more packet in its buffer for which there was no first round request and in case one or more of the first round requests is rejected, the input controller immediately prepares second priority request packets (not shown) for use in a second (or third) request sub-cycle.

2. Request switch 104 receives the first bits of the request packet at time T_{R}, and sends the packet to the target request processor specified in OPA field 204 of the request.

3. In this example, the request processor receives up to three requests that arrive serially starting at time T₃.

4. When the third request has arrived at time T₄, the request processor ranks the requests based on priority information in the packets, and may select one or more requests to accept. Each request packet contains the address of the requesting input controller. The address of the requesting input controller is used as the target address of the answer packet.

5. Answer switch 108 transmits using the IPA address to send the acceptance packets to the input controller making the requests.

6. The input controller receives acceptance notification at time T₆ and sends the data packet associated with the acceptance packet into the data switch at the start of the next data cycle 640. Data packets from the input controllers enter the data switch at time T_{D}.

7. The request processor generates rejection answer packets 250 and sends them through the answer switch to the input controllers making the rejected requests.

8. When the first rejection packet is generated, it is sent into the answer switch 108 followed by other rejection packets. The final rejection packet is received by the input controller at time T₈. This marks the completion of the request cycle, or the first sub-cycle in embodiments employing multiple request sub-cycles.

9. Request cycle 160 starts at time T_{R} and ends at time T₈ for duration T_{RQ}. In an embodiment that supports request sub-cycles, request cycle 610 is considered to be the first sub-cycle. The second sub-cycle 612 begins at time T₈ after all of the input controllers have been informed of the accepted and rejected requests. During the time between T₃ and T₈, an input controller with packets for which there was no request on the first cycle, builds request packets for the second sub-cycle. These requests are sent at time T₈. When more than one sub-cycle is used, the data packets are sent into the data switch at the completion of the last sub-cycle (not shown).

This overlapped processing method advantageously permits the control system to keep pace with the data switch. This overlapped processing method advantageously permits the control system to keep pace with the data switch.

FIG. 6C is a timing diagram of an embodiment of a control system that supports a special multicast processing cycle. In this embodiment multicast requests are not permitted at non-multicast (normal) request cycles, RC 610. An input controller that has a packet for multicast waits until the multicast request cycle, MCRC 650, to send its request. Accordingly, multicast requests do not compete with normal requests, advantageously increasing the likelihood that all targets ports of the multicast will be available. The ratio of normal to multicast cycles and their timing are dynamically controlled by the system processor 140.

FIG. 6D is a timing diagram of an embodiment of a control system that supports time-slot reservation scheduling discussed with FIGS. 3A, 3B and 3C. This embodiment exploits the fact that, on average, a data packet is subdivided into a significant number of segments and only one request is made for all segments of a packet. A single time-slot reservation request packet 310 is sent and answer packet 320 is received during one time-slot request cycle, TSRC 660. After the answer is received, the plurality of segments are sent during shorter, time-slot data cycles, TSDC 662, at the rate of one segment per TSDC cycle. In an example, assume that the average data packet is broken into 10 segments. This means that for every 10 segments sent into the data switch, the system has to perform only one TSRC cycle. Thus, request cycle 660 could be 10 times longer than the data cycle 662, and control system 120 could still handle all incoming traffic. In practice, a ratio less than the average should be used to accommodate situations where an input port receives a burst of short packets.

Power Saving Schemes

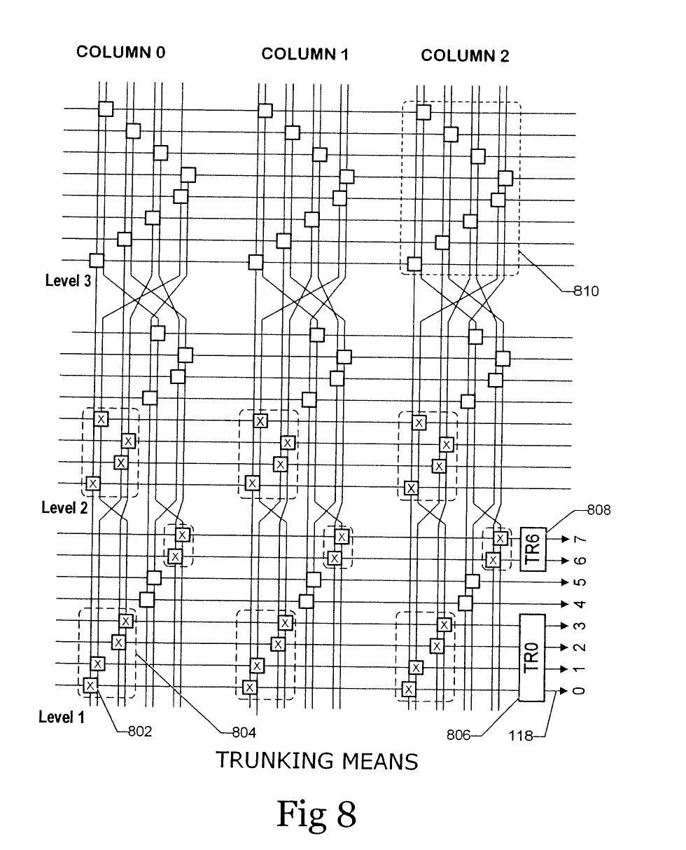

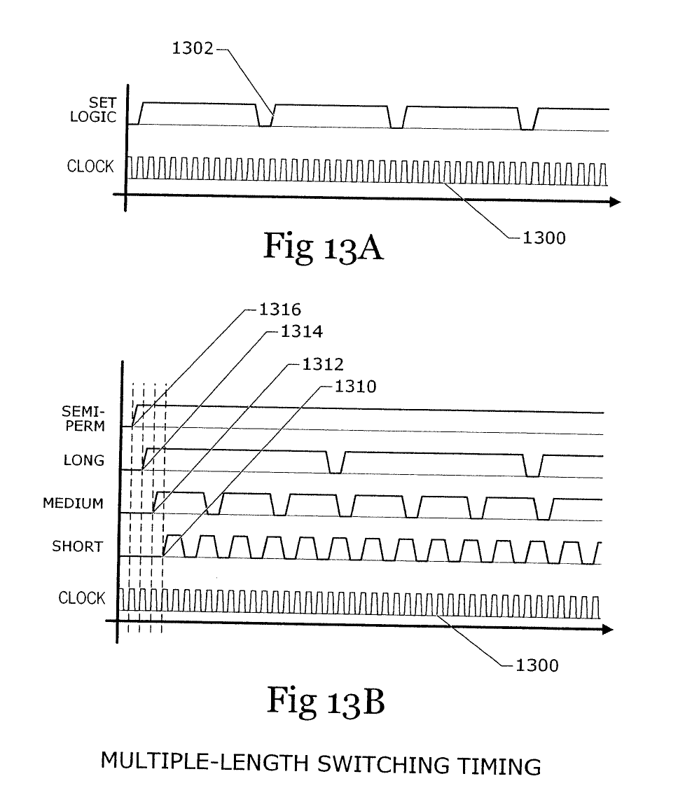

There are two components in the MLML switch fabric that serially transmit packet bits. These are: 1) Control cells and 2) FIFO buffers at each row of the switch fabric. Referring to FIGS. 8 and 13A, a clock signal 1300 causes data bits move in bucket-brigade fashion through these components. In a preferred embodiment of the MLML switch fabric, simulations indicate that only 10% to 20% of these components have a packet transiting through them at a given time; the remainder are empty. But even when there is no packet present (all zeros) the shift registers consume power. In a power-saving embodiment the clock signal is appropriately turned off when no packet is present.

In a first power-saving scheme, the clock driving a given cell is turned off as soon as the cell determines that no packet has entered it. This determination takes only a single clock cycle for a given control cell. At the next packet arrival time 1302 the clock is turned on again, and the process repeats. In a second power-saving scheme, the cell that sends a packet to the FIFO on its row determines whether or not a packet will enter the FIFO. Accordingly, this cell turns the FIFO's clock on or off.

If no cell in an entire control array 810 is receiving a packet, then no packets can enter any cell or FIFO to the right of the control array on the same level. In a third power-saving scheme, when no cell in a control array sends a packet to its right, the clocks are turned off for all cells and FIFOs on the same level to the right of this control array.

Configurable Output Connections

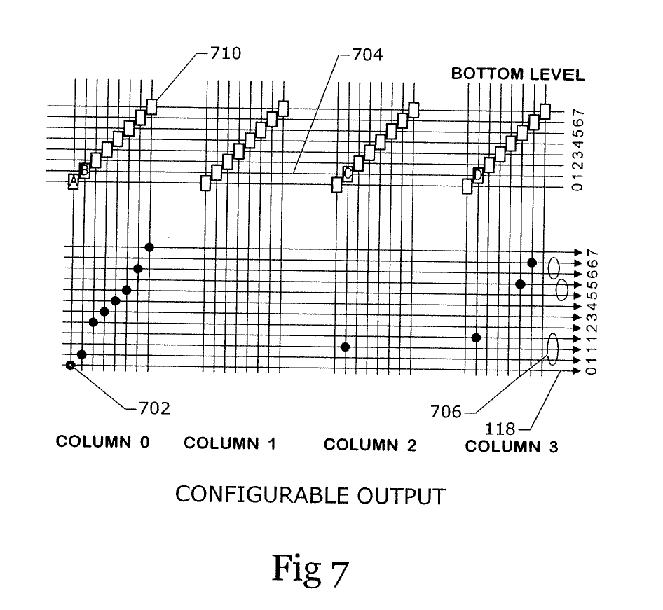

The traffic rate at an output port can vary over time, and some output ports can experience a higher rate than others. FIG. 7 is a diagram of the bottom level of an MLML data switch of the type taught in Inventions #2 and #3 showing how configurable connections are made to physical output ports 118. A node 710 at the bottom level of the switch has a settable connection 702 to an output port 118 of the switch chip. Node A on row address 0 connects by means of link 702 to one output port 118; nodes B, C and D are on row 1, 704 and have the same output address. At three columns, nodes B, C and D connect to three different physical output ports 706. Similarly, output addresses 5 and 6 each connect to two output ports. Accordingly, output addresses 1, 5 and 6 have higher bandwidth capacity at the data switch output.

Trunking

Trunking refers to the aggregation of a plurality of output ports that are connected to a common downstream connection. At the data switch, output ports connected to one trunk are treated as a single address, or block of addresses, within the data switch. Different trunks can have different numbers of output port connections. FIG. 8 is a diagram of the bottom levels of an MLML data switch of the type taught Inventions #2 and #3 that has been modified to support trunking. A node is configured by a special message sent by the system processor 140 so that it either reads or ignores header address bits. A node 802, indicated by “x”, ignores packet header bits (address bits) and routes the packet down to the next level. Nodes at the same level that reach the same trunk are shown inside a dashed box 804. In the illustration, output addresses o, 1, 2 and 3 connect to the same trunk, TR0 806. A data packet sent to any of these addresses will exit the data switch at any of the four output ports 118 of TR0. Alternately stated, a data packet with output address 0, 1, 2 or 3 will exit the switch at any of the four ports of trunk TR0. Statistically, any output port 118 of trunk TR0 806 is equally likely to be used, regardless of the packet's address: 0, 1, 2 or 3. This property advantageously smoothes out traffic flowing out from among the plurality of output connections 118. Similarly, packets sent to address 6 or 7 are sent out trunk TR6 808.

Parallelization for High-Speed I/O and More Ports

When segmentation and reassembly (SAR) is utilized, the data packets sent through the switch contain segments rather than full packets. In one embodiment of the system illustrated in FIG. 1A employing the timing scheme illustrated in FIG. 6D, the request processors can, at one time, give permission for all of the segments of a packet to be sent to their target output controller. The input controller makes a single request that indicates how many segments are in the complete packet. The request processor uses this information in ranking requests; when a multi-segment request has been granted, the request processor does not allow any subsequent request until such time that all segments have been sent. The input controllers, the request switch, request processors, and the answer switch desirably have a reduced workload. In such an embodiment the data switch is kept busy while the request processor is relatively idle. In this embodiment, request cycle 660 can be of longer duration than data (segment) switch cycle 662, advantageously relaxing design and timing constraints for the control system 120.

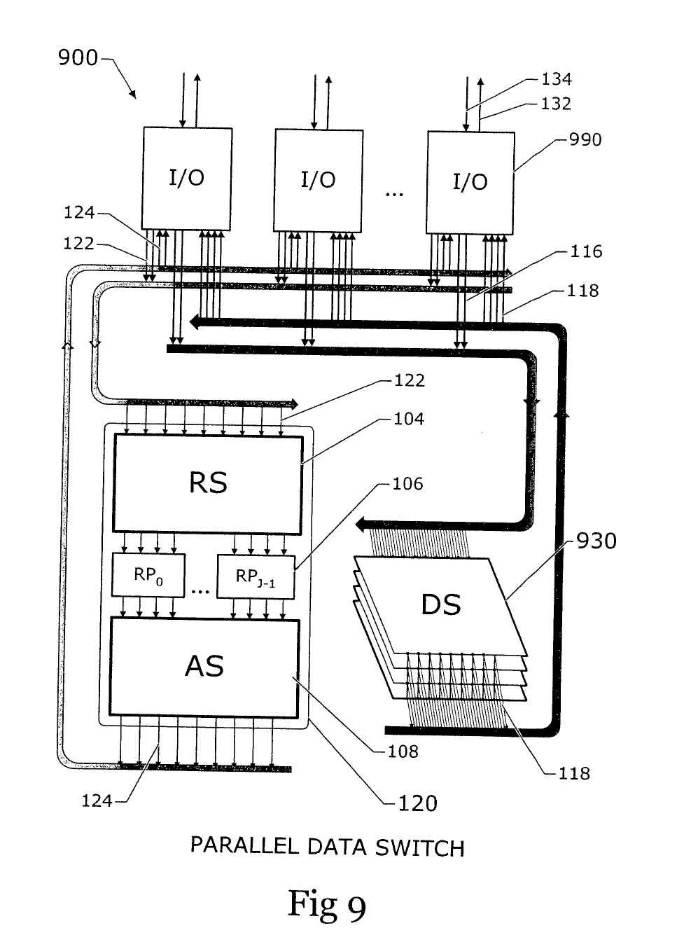

In another embodiment the rate through the data switch is increased without increasing the capacity of the request processor. This can be achieved by having a single controller 120 managing the data going into multiple data switches, as illustrated by the switch and control system 900 of FIG. 9. In one embodiment of this design, in a given time period, each of the input controllers 990 is capable of sending a packet to each of the data switches in the stack of data switches 930. In another embodiment the input controller can decide to send different segments of the same packet to each of the data switches, or it can decide to send segments from different packets to the data switches. In other embodiments, at a given time step, different segments of the same packet are sent to different data switches. In yet another embodiment, one segment is sent to the entire stack of data switches in bit-parallel fashion, reducing the amount of time for the segment to wormhole through the data switch by an amount proportional to the number of switch chips in the stack.

In FIG. 9, the design allows for a plural number of data switches that are managed by request controller 120 with a single request switch and a single answer switch. In other designs, the request controller contains a plural number of request switches 104 and a plural number of answer switches 108. In yet other designs, there are a multiple number of request switches and a multiple number of answer switches as well as a multiple number of data switches. In the last case, the number of data switches could be equal to the number of request control units or the number of request processors could be either greater than or less than the number of data switches.

In the general case, there are P request processors that handle only multicast requests, Q data switches for handling only multicast packets, R request processors for handling direct requests, and S data switches for handling direct addressed data switching.

A way to advantageously employ multiple copies of request switches is to have each request switch receive data on J lines with one line arriving from each of the J input controller processors. In this embodiment, one of the duties of the input processors is to even out the load to the request switches. The request processors use a similar scheme in sending data to the data switch.

Referring to FIG. 1D, a system processor 140 is configured to send data to and receive data from the line cards, the input processors, and the request processors, and to communicate with external devices outside of the system, such as an administration and management system. Data switch I/O ports 142 and 144, and control system I/O ports, 146 and 148, are reserved for use by the system processor. The system processor can use the data received from the input processors and from the request processors to inform a global management system of local conditions, and to respond to the requests of the global management system. The algorithms and methods that the request processors use to make their decisions can be based on a table lookup procedure, or on a simple ranking of requests by a single-value priority field. Based on information from within and without the system, the system processor can alter the algorithm used by the request processors, for example by altering their lookup tables. An IC WRITE message (not shown) is sent on path 142 into the data switch to an output controller 110 that transmits over path 152 to the associated input controller 150. Similarly, an IC READ message is sent to an input controller, which responds by sending its reply through the data switch to the port address 144 of the system processor. An RP WRITE message (not shown) is used to send information to a request processor on path 146 using the request switch 104. An RP READ message is similarly used to interrogate a request processor, which sends its reply through answer switch 108 to the system processor on path 148.

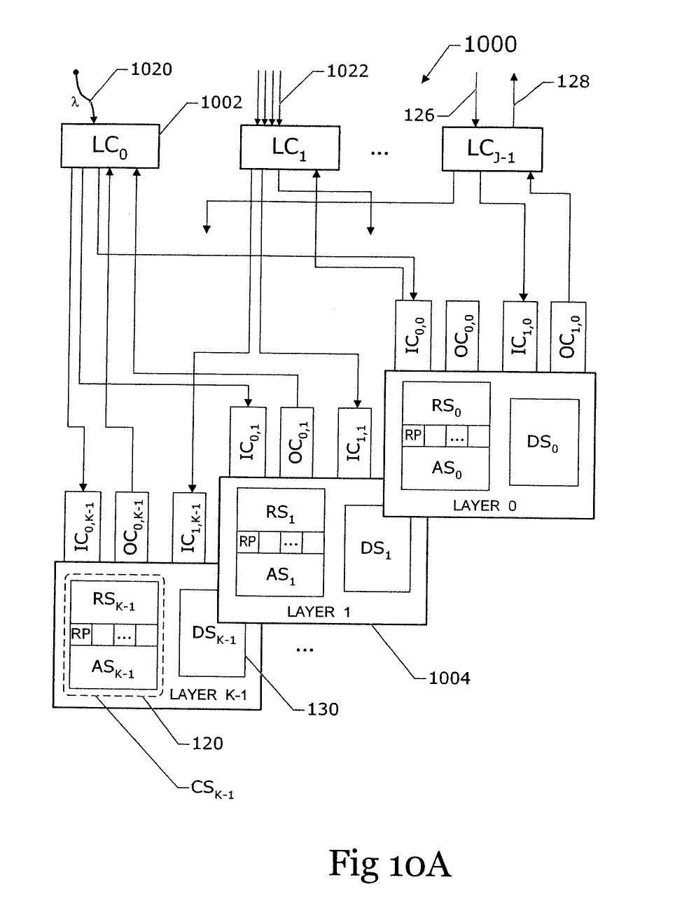

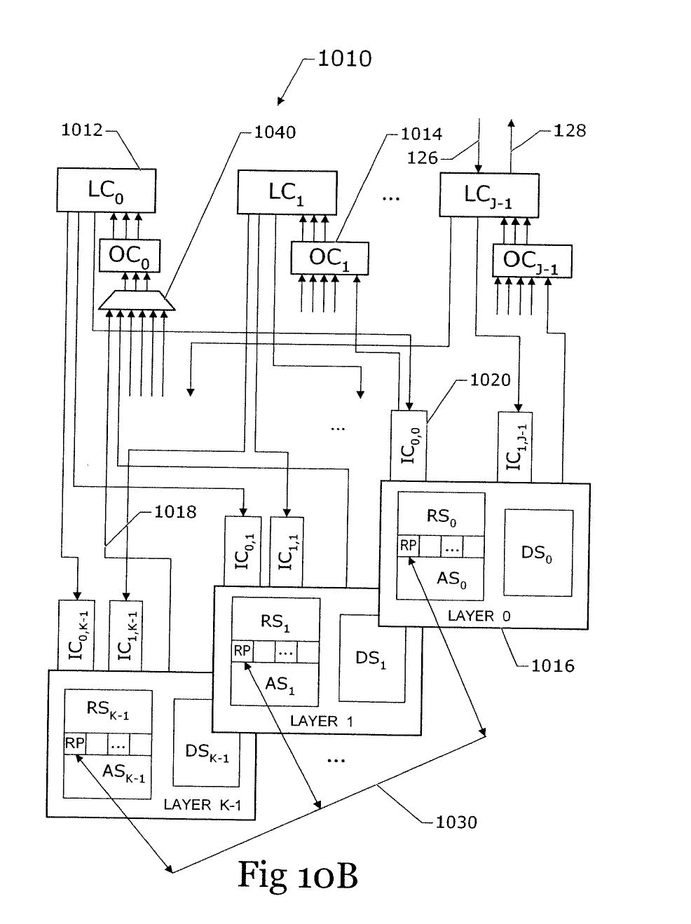

FIG. 10A illustrates a system 1000 where yet another degree of parallelism is achieved. Multiple copies of the entire switch, 100 or 900, including its control system and data switch, are used as modules to construct larger systems. Each of the copies is referred to as a layer 1004; there can be any number of layers. In one embodiment, K copies of the switch and control system 100 are used to construct a large system. A layer may be a large optical system, a layer may consist of a system on a board, or a layer may consist of a system in one rack, or of many racks. It is convenient in what follows to think of a layer as consisting of a system on a board. In this way, a small system can consist of only one board (one layer) whereas larger systems consist of multiple boards.

For the simplest layer, as depicted in FIG. 1A, a list of the components on a layer m follows:

One data switch DSₘ

One request switch RSₘ

One request processor, RCₘ

One answer switch ASₘ

J request processors, RP_{o,m}, RP_{1,m}, . . . RP_{J-1,m}

J input controllers, IC_{0,m}, IC_{1,m}, . . . IC_{J-1,m}

J output controllers, OC_{0,m}, OC_{1,m}, . . . OC_{J-1,m}

A system with the above components on each of K layers has the following “parts count:” K data switches, K request switches, K answer switches, J·K input controllers, J·K output controllers and J·K request processors.

In one embodiment, there are J line cards LC₀, LC₁, . . . LC_{J-1}, with each line card 1002 sending data to every layer. In this embodiment, the line card LCₙ feeds the input controllers IC_{n,0}, IC_{n,1}, . . . , IC_{n,k-1}. In an example where an external input line 1020 carries wave division multiplexed (WDM) optical data with K channels, the data can be demultiplexed and converted into electronic signals by optical-to-electronic (O/E) units. Each line card receives K electronic signals. In another embodiment, there are K electronic lines 1022 into each line card. Some of the data input lines 126 are more heavily loaded than others. In order to balance the load, the K signals entering a line card from a given input line can advantageously be placed on different layers. In addition to demultiplexing the incoming data, line cards 1002 can re-multiplex the outgoing data. This may involve optical-to-electronic conversion for the incoming data and electronic-to-optical conversion for the outgoing data.

All of the request processors RP_{N,0}, RP_{N,1}, . . . RP_{N,K-1} receive requests to send packets to the line card L_{CN}. In one embodiment illustrated in FIG. 10A, there is no communication between the layers. There are K input controllers and K output controllers corresponding to a given line card. Thus, each line card sends data to K input controllers and receives data from K output controllers. Each line card has a designated set of input ports corresponding to a given output controller. This design makes the reassembly of segments as easy as in the earlier case where there is only one layer.

In the embodiment of FIG. 10B there are also J·K input controllers, but only J output controllers. Each line card 1012 feeds K input controllers 1020, one on each layer 1016. In contrast to FIG. 10A, there is only one line card associated with each output controller 1014. This configuration results in the pooling of all of the output buffers. In embodiment 1010, in order to give the best answers to the requests it is advantageous for there to be a sharing of information between all of the request processors that govern the flow of data to a single line card. In this way, using inter-layer communications links 1030, the request processors RP_{N,0}, RP_{N,1}, . . . RP_{N,k-1} share information concerning the status of the buffers in line card LC_{N}. It may be advantageous to place a concentrator 1040 between each data switch output 1018 and output controller 1014. Invention #4 describes a high data rate concentrator with the property that given the data rates guaranteed by the request processors, the concentrators successfully deliver all entering data to their output connections. These MLML concentrators are the most suitable choice for this application. The purpose of the concentrators is to allow a data switch at a given layer to continue to deliver an excessive amount of data to the concentrator provided that data from other layers are light during that period. Therefore in the presence of unbalanced loads and bursty traffic, the integrated system of K layers can achieve a higher bandwidth than K unconnected layers. This increased data flow is made possible by the request processor's knowledge of all of the traffic entering each of the concentrators. A disadvantage of such a system is that more buffering and processing is required to reassemble the packet segments, and there are J communication links 1030.

Twisted Cube Embodiment

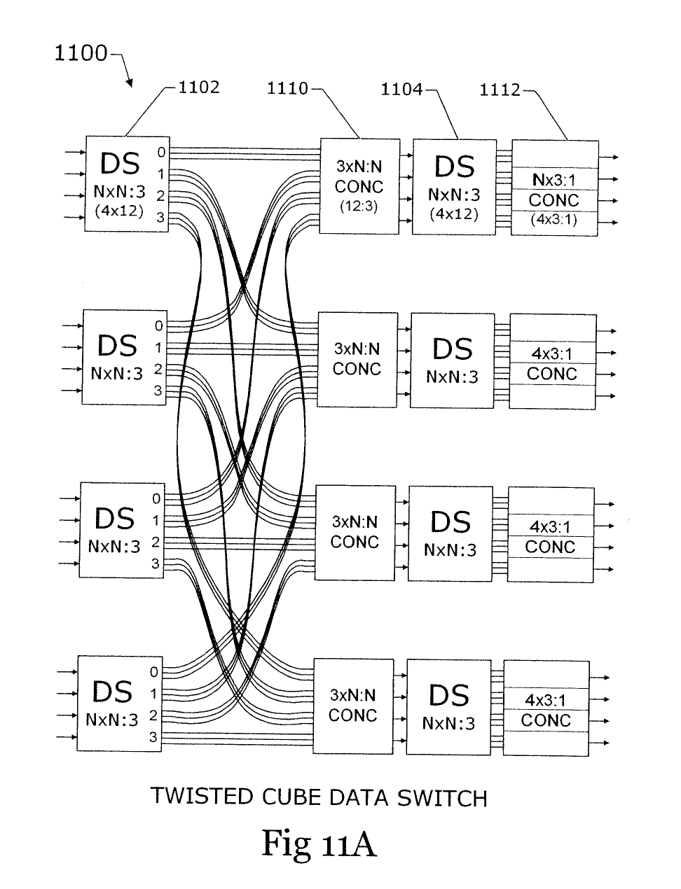

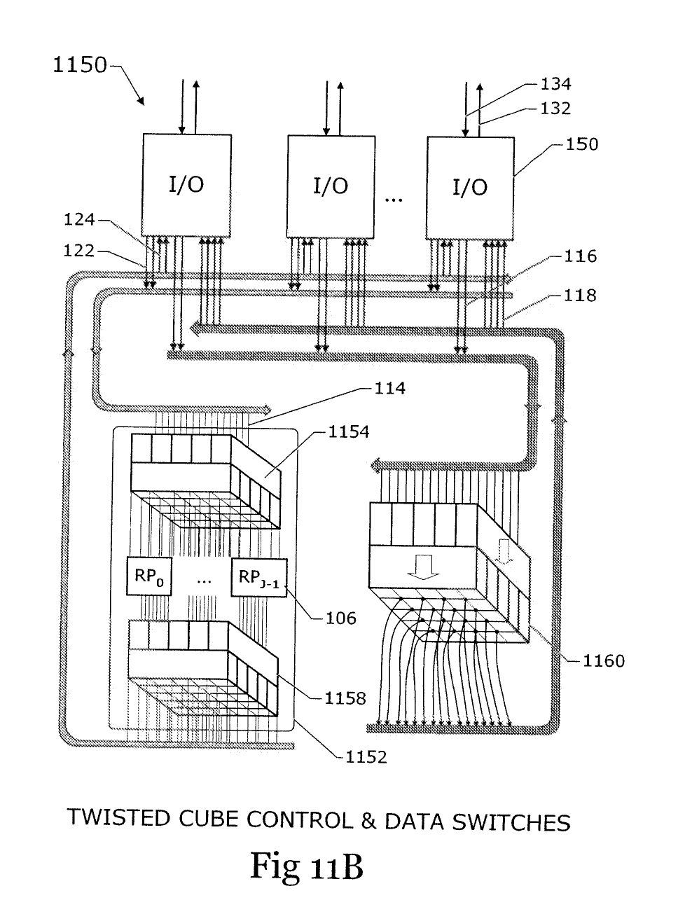

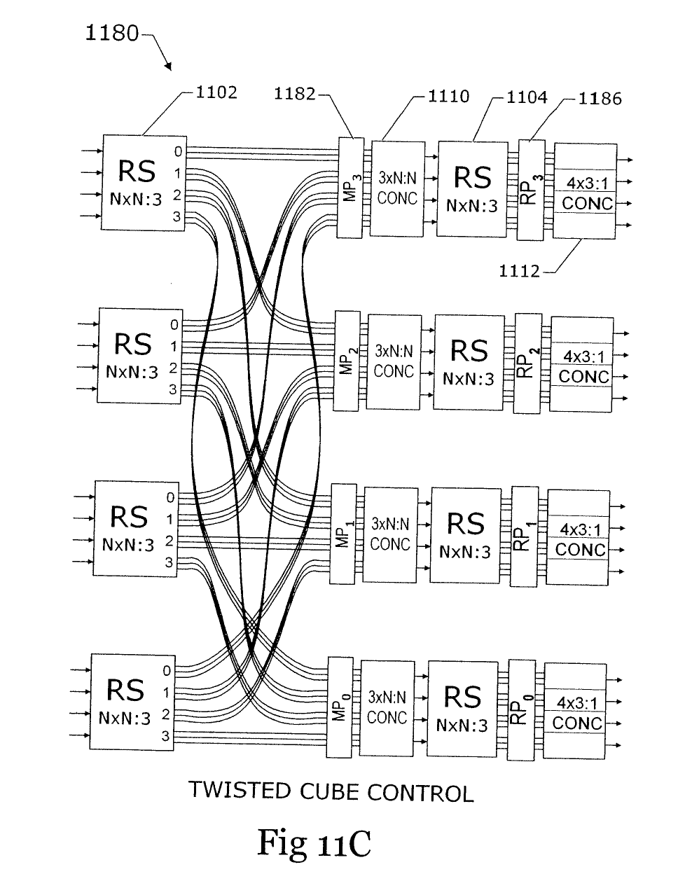

The basic system consisting of a data switch and a switch management system is depicted in FIG. 1A. Variants to increase the bandwidth of the system without increasing the number of input and output ports are illustrated in FIGS. 9, 10A and 10B. The purpose of the present section is to show how to increase the number of input ports and output ports while simultaneously increasing the total bandwidth. The technique is based on the concept of two “twisted cubes” in tandem, where each cube is a stack of MLML switch fabrics. A system that contains MLML networks and concentrators as components is described Invention #4. An illustration of a small version of a twisted cube system is illustrated in FIG. 11A. System 1100 can be either electronic or optical; it is convenient to describe the electronic system here. The basic building block of such a system is an MLML switch fabric of the type taught Inventions #2 and #3 that has N rows and L columns on each level. On the bottom level there are N rows, with L nodes per row. On each row on the lowest level there are M output ports, where M is not greater than L. Such a switch network has N input ports and N·M output ports. A stack of N switches 1102 is referred to as a cube; the following stack of N switches 1104 is another cube, twisted 90 degrees with respect to the first cube.

The two cubes are shown in a flat layout in FIG. 1A, where N=4. A system consisting of 2N such switching blocks and 2N concentrator blocks has N² input ports and N² output addresses. The illustrative small network shown in FIG. 11A has eight switch fabrics 1102 and 1104, each with 4 inputs and output addresses. Thus, the entire system 1100 forms a network with 16 inputs and 16 outputs. Packets enter an input port of the switches 1102 that fix the first two bits of the target output. The packets then enters MLML concentrator 1110 that smoothes out the traffic from 12 output ports of the first stack to match the 4 input ports of one switch in the second stack. All of the packets entering a given concentrator have the same N/2 most-significant address bits, two bits in this example. The purpose of the concentrators is to feed a larger number of relatively lightly loaded lines into a smaller number of relatively heavily loaded lines. The concentrator also serves as a buffer that allows bursty traffic to pass from the first stack of switches to the second stack. A third purpose of the concentrator is to even out the traffic into the inputs of the second set of data switches. Another set of concentrators 1112 is also located between the second set of switches 1104 and the final network output ports.

Given that a large switch of the type illustrated FIG. 1A is used for the switch modules of a system 100 shown in FIG. 1A, there are two methods of implementing request controllers 120. The first method is to use the twisted cube network architecture of FIG. 11A in place of the switches RS 104 and AS 108. In this embodiment there are N² request processors that correspond to the N² system output ports. The request processors can either precede or follow the second set of concentrators 1112. FIG. 11B illustrates a large system 1150 that uses twisted-cube switch fabrics for request switch module 1154 and answer switch module 1158 in request controller 1152, and for data switch 1160. This system demonstrates the scalability of the interconnect control system and switch system taught here. Where N is the number of I/O ports of one switch component, 1102 and 1104, of a cube, there are N² total I/O ports for the twisted-cube system 1100.

Referring to FIGS. 1A, 11A and 11B in an illustrative example, a single chip contains four independent 64-port switch embodiments. Each switch embodiment uses 64 input pins and 192 (3·63) output pins, for a total of 256 pins per switch. Thus, the four-switch chip has 1024 (4·256) I/O pins, plus timing, control signal and power connections. A cube is formed from a stack of 16 chips, altogether containing 64 (4·16) independent MLML switches. This stack of 16 chips (one cube) is connected to a similar cube; and so 32 chips are needed per twisted-cube set. All 32 chips are preferably mounted on a single printed circuit board. The resulting module has 64·64, or 4,096, I/O ports. Switch system 1150 uses three of these modules, 1154, 1158 and 1160, and has 4,096 available ports. These I/O ports can be multiplexed by line cards to support a smaller number of high-speed transmission lines. Assume each electronic I/O connection, 132 and 134, operates at a conservative rate of 300 Megabits per second. Therefore, 512 OC-48 optical fiber connections operating at 2.4 Gigabits per second each are multiplexed at a 1:8 ratio to interface with the 4,096 electronic connections of twisted-cube system 1150. This conservatively designed switch system provides 1.23 Terabits per second of cross-sectional bandwidth. Simulations of the switch modules show that they easily operate at a continuous 80% to 90% rate while handling bursty traffic, a figure that is considerably superior to large, prior art, packet-switching systems. One familiar with the art can easily design and configure larger systems with faster speeds and greater capacities.

A second method of managing a system that has a twisted cube for a switch fabric adds another level of request processors 1182 between the first column of switches 1102 and the first column of concentrators 1110. This embodiment, control system 1180, is illustrated in FIG. 11C. There is one request processor, MP 1182, corresponding to each of the concentrators between the data switches. These middle request processors are denoted by MP₀, MP₁, . . . MP_{J-1}. One role of the concentrators is to serve as a buffer. The strategy of the middle processors is to keep the concentrator buffer 1110 from overflowing. In case a number of input controllers send a large number of requests to flow through one of the middle concentrators 1110, that concentrator could become overloaded and not all of the requests would arrive at the second set of request processors. It is the purpose of the middle processors 1182 to selectively discard a portion of the requests. The middle request processors 1182 can make their decisions without knowledge of the status of the buffers in the output controllers. They only need to consider the total bandwidth from the middle request processors to the middle concentrators 1110; the bandwidth from the middle concentrators to the second request switch 1104; the bandwidth in the second switch 1104; and the bandwidth from the second switch to the request processor 1186. The middle processor considers the priority of the requests and discards those that would have been discarded by the request processors had they been sent to those processors.

Single-Length Routing

FIG. 12A is a diagram of a node of a type used in the MLML interconnects disclosed in the patents incorporated by reference. Node 1220 has two horizontal paths 1224 and 1226, and two vertical paths 1202 and 120, for packets. The node includes two control cells, R and S 1222, and a 2×2 crossbar switch 1218 that permits either control cell to use either downward path, 1202 or 1204. As taught in Inventions #2 and #3, a packet arriving at cell R from above on 1202 is always immediately routed to the right on path 1226; a packet arriving at cell S from above on 1204 is always immediately routed to the right on path 1224. A packet arriving at cell R from the left is routed downward on a path that takes it closer to its target, or if that path is not available the packet is always routed to the right on path 1226; a packet arriving at cell S from the left is routed downward on a path that takes it closer to its target, or if that path is not available it is always routed to the right on path 1224. If a downward path is available and if cells R and S each have a packet that wants to use that path, then only one cell is allowed to use that downward path. In this example, cell R is the higher priority cell and gets first choice to use the downward path; cell S is thereby blocked and sends its packet to the right on path 1224. Each cell, R and S, has only one input from the left and one output to the right. Note that when its path to the right is in use, the cell cannot accept a packet from above: a control signal (running parallel to paths 1202 and 1204, not shown) is sent upward to a cell at a higher level. By this means, a packet from above that would cause a collision is always prevented from entering a cell. Importantly, any packet arriving at a node from the left always has an exit path available to it to the right and often an exit available downward toward its target, desirably eliminating the need for any buffering at a node and supporting wormhole transmission of traffic through the MLML switch fabric.

FIG. 13A is a timing diagram for node 1220 illustrated in FIG. 12A. The node is supplied with a clock 1300 and a set-logic signal 1302. Global clock 1300 is used to step packet bits through internal shift registers (not shown) in cells, one bit per clock period. Each node contains a logic element 1206 that decides which direction arriving packet(s) are sent. Header bits of packets arriving at the node, and control-signal information from lower-level cells, are examined by logic 1206 at set-logic time 1302. The logic then decides (1) where to route any packet: downward or to the right, (2) how to set crossbar 1218, and (3) stores these settings in internal registers for the duration of the packet's transit through the node. At the next set-logic time 1302 this process is repeated.

The data switch with its control system that is the subject of this invention is well suited to handle long packets at the same time as short segments. A plurality of packets of different lengths efficiently wormhole their way through an embodiment of a data switch that supports this feature. An embodiment that supports a plurality of packet lengths and does not necessarily use segmentation and reassembly is now discussed. In this embodiment the data switch has a plurality of sets of internal paths, where each set handles a different length packet. Each node in the data switch has at least one path from each set passing through it.

FIG. 12B illustrates a node 1240 with cells P and Q that desirably supports a plurality of packet lengths, four lengths in this example. Each cell 1242 and 1244 in node 1240 has four horizontal paths, which are transmission paths for packets of four different lengths. Path 1258 is for the longest packet or for a semi-permanent connection, path 1256 is for packets that are long, path 1254 is for packets of medium length, and path 1252 is used for the shortest length. FIG. 13B is a timing diagram for node 1240. There is a separate set-logic timing signal for each of the four paths: set-logic signal 1310 pertains to short-length packets on path 1252; signal 1312 pertains to medium-length packets on path 1254; signal 1314 pertains to long packets on path 1256; and signal 1316 pertains to semi-permanent connections on path 1258. It is important that a connection for a longer-length packet should be set up in the node before shorter lengths. This gives longer length packets a greater likelihood of using downward paths 1202 and 1204 and therefore exiting the switch earlier, which increases overall efficiency. Accordingly, semi-permanent signal 1316 is issued first. Signal 1314, which is for long packets, is issued one clock period after semi-permanent signal 1316. Similarly, signal 1312 for medium length packets is issued one clock period later, and short packet signal 1310 is issued one clock period after that.

Cell P 1242 can have zero, one, two, three, or four packets entering at one time from the left on paths 1252, 1254, 1256 and 1258, respectively. Of all packets arriving from the left, zero or one of them can be sent downward. Also at the same time, it can have zero or one packet entering from above on 1202, but only if the exit path to the right for that packet is available. As an example, assume cell P has three packets entering from the left: a short, a medium, and a long packet. Assume the medium packet is being sent down (the short and long packets are being sent to the right). Consequently, the medium and semi-permanent paths to the right are unused. Thus, cell P can accept either a medium or semi-permanent packet from above on 1202, but cannot accept a short or long packet from above. Similarly, cell Q 1244 in the same node can have zero to four packets arriving from the left, and zero or one from above on path 1204. In another example, cell Q 1244 receives four packets from the left, and the short-length packet on path 1252 is routed downward on path 1202 or 1204, depending on the setting of crossbar 1218. Consequently, the short-length exit path to the right is available. Therefore cell Q allows a short packet (only) to be send down to it on path 1204. This packet is immediately routed to the right on path 1254. If the cell above did not have a short packet wanting to come down, then no packet is allowed down. Accordingly, the portion of the switch using path 1258 forms long-term input-to-output connections, another portion using paths 1256 carry long packets, such as a SONET frame, paths 1254 carry long IP packets and Ethernet frames, and paths 1252 carry segments or individual ATM cells. Vertical paths 1202 and 1204 carry packets of any length.

Multiple-Length Packet Switch

FIG. 14 is a circuit diagram of a portion of a switch supporting the simultaneous transmission of packets of different lengths, and connections showing nodes in two columns and two levels of the MLML interconnect fabric. The nodes are of the type shown in FIG. 12B, which support multiple packet lengths; only two lengths are shown to simplify the illustration: short 1434 and long 1436. Node 1430 contains cells C and D that each has two horizontal paths, 1434 and 1436, through them. Cell C 1432 has a single input from above 1202 and shares both paths below, 1202 and 1204, with cell D. Vertical paths 1202 and 1204 can carry either length of transmission. Two packets have arrived at cell L from the left. A long packet, LP1, arrives first and is routed downward on path 1202. A short packet, SP1, arrives later and also wants to use path 1202; it is routed to the right. Cell L allows a long packet to come down from the node containing cells C and D, but cannot allow a short packet because short path to the right 1434 is in use. Cell C receives a long packet, LP2, that wants to move down to cell L; cell L permits it to come, and cell C sends LP2 down path 1204 to cell L, which always routes it to the right. Cell D receives a short packet, SP2, that also wants to go down path 1204 to cell L, but D cannot send it down because path 1204 is in use by the long packet, LP2. Furthermore, even if there were no long packet from C to L, cell D cannot send its short packet down because cell L has blocked the sending of a short packet from above.

Chip Boundry

In systems such as the ones illustrated in FIGS. 1A, 1D, 1E, and 1F it is possible to place a number of the system components on a single chip. For example in the system illustrated in FIG. 1E, the input controllers (ICs) and output controllers and request processor combined with the output controllers (RP/OCs) may have logic that is specific to the type of message that is to be received from the line card. So that the input controllers for line cards that receive ATM messages might be different than the input controllers that receive Internet protocol messages or Ethernet frames. The ICs and RP/OCs and also contain buffers and logic that are common to all of the system protocols.

In one embodiment, all or a plurality of the following components can be placed on a single chip:

the request and data switch (RS/DS);

the answer switch (AS);

the logic in the ICs that is common to all protocols;

a portion of the IC buffers;

the logic on the OC/RPs that are common to all protocols;

a portion of the OC/RP buffers;

A given switch may be on a chip by itself or it may lie on several chips or it may consist of a large number of optical components. The input ports to the switch may be physical pins on a chip, they may be at optical-electrical interfaces, or they may merely be interconnects between modules on a single chip.

High Data Rate Embodiment

In many ways, physical implementations of systems described in this patent are pin limited. Consider a system on a chip discussed in the previous section. This will be illustrated by discussing a specific 512×512 example. Suppose in this example that low-power differential logic is used and two pins are required per data signal, on and off the chip. Therefore, a total of 2048 pins are required to carry the data on and off the chip. In addition, 512 pins are required to send signals from the chip to the off-chip portion of the input controllers. Suppose, in this specific example, that a differential-logic pin pair can carry 625 megabits per second (Mbps). Then a one-chip system can be used as a 512×512 switch with each differential pin-pair channel running at 625 Mbps. In another embodiment the single chip can be used as a 256×256 switch with each channel at 1.25 gigabits per second (Gbps). Other choices include 125×125 switch at 2.5 Gbps; 64×64 at 5 Gbps or 32×32 at 10 Gbps. In case a chip with an increased data rate and fewer channels is used, multiple segments of a given message can be fed into the chip at a given time. Or segments from different messages arriving at the same input port can be fed into the chip. In either case, the internal data switch is still a 512×512 switch with the different internal I/Os used to keep the various segments in order. Another option includes the master-slave option of patent #2. In yet another option, internal, single line data carrying lines can be replaced by a wider bus. The bus design is an easy generalization and that modification can be made by one skilled in the art. In order to build systems with the higher data rates, systems such as illustrated in FIG. 10A and FIG. 10B can be employed. For example a 64×64 port system with each line carrying 10 Gbps can be built with two switching system chips; a 128×128 port system with each line carrying 10 Gbps can be built with four switching system chips. Similarly 256×256 systems at 10 Gbps require 8 chips and 512×512 systems at 10 Gbps require 16 chips.

Other technologies with fewer pins per chip can run at speeds up to 2.5 Gbps per pin pair. In cases where the I/O runs faster than the chip logic, the internal switches on the chip can have more rows on the top level than there are pin pairs on the chip.

Automatic System Repair

Suppose one of the embodiments described in the previous system is used and N system chips are required to build the system. As illustrated in FIG. 10A and FIG. 10B, each of the system chips is connected to all of the line cards. In a system with automatic repair, N+1 chips are employed. These N chips are labeled C_{O}, C₁, . . . , C_{N}. In normal mode chips C₁, C₁, . . . , C_{N-1} are used. A given message is broken up into segments. Each of the segments of a given message is given an identifier label. When the segments are collected, the identifier labels are compared. If one of the segments is missing, or has an incorrect identifier label, then one of the chips is defective and the defective chip can be identified. In the automatic repair system, the data path to each chip C_{K} can be switched to C_{K+1}. In this way if chip J is found to be defective by an improper identifier label, then that chip can be automatically switched out of the system.

System Input-Output

Chips that receive a large number of lower data rate signals and produce a small number of higher data rate signals, as well as chips that receive a small number of high data rate signals and produce a large number of high data rate signals are commercially available. These chips are not concentrators but simply data expanding or reducing multiplexing (mux) chips. 16:1 and 1:16 chips are commercially available to connect a system using 625 Mbps differential logic to 10 Gbps optical systems. The 16 input signals require 32 differential logic pins Associated with each input/output port, the system requires one 16:1 mux; one 1:16 mux; one commercially available line card; and one IC-RP/OC chip. In another design, the 32:1 concentrating mux is not used and the 16 signals feed 16 lasers to produce a 10 Gpbs WDM signal. Therefore, using today's technology, a 512×512 fully controlled smart packet switch system running at a full 10 Gbps would require 16 custom switch system chips, and 512 I/O chip sets. Such a system would have a cross sectional bandwidth of 5.12 terabits per second (Tbps).

Another currently available technology allows for the construction of a 128×128 switch chip system running at 2.5 Gbps per port. The 128 input ports would require 256 input pins and 256 output pins. Four such chips could be used to form a 10 Gbps packet switching system.

The foregoing disclosure and description of the invention is illustrative and exemplary thereof, and variations may be made within the scope of the appended claims without departing from the spirit of the invention.

1. An internet protocol switching system comprising a plurality of input ports connected by a data switch S to a plurality of output ports, having an input port A as one of the plurality of input ports and an output port X as one of the plurality of output ports, and
a message packet MA at input port A, wherein a decision to inject message packet MA into S is based at least in part on logic associated with output port X.

2. An internet protocol switching system in accordance with claim 1, further including an input port B and a message packet MB at input port B wherein the logic at output port X bases in part the decision to inject message packet MA into data switch S on information about message MB.

3. An internet protocol switching system in accordance with claim 2, wherein message packets MA and MB are targeted for output port X.

4. An internet protocol switching system in accordance with claim 2, wherein the timing of the injection of MA into data switch S depends at least in part on the arrival of one or more message packets at input port B.

5. A method for sending a message packet MA through an interconnect structure, said interconnect structure having at least two input ports A and B, the message packet MA arriving at input port A, the method comprising the steps of:
monitoring the arrival of individual message packets at input port B; and
basing the possible scheduling of the injection of all or part of message packet MA into the interconnect structure, at least in part on the monitoring of individual message packets arriving at input port B.

6. A method for sending a message MA through an interconnect structure, said interconnect structure having an input port A and a plurality of output ports including an output port X, and all or part of message MA arriving at input port A, the method comprising the steps of:
monitoring logic associated with output port X; and
basing a decision to inject message MA into the interconnect structure, at least in part on information concerning a message MB targeted for X and entering the interconnect structure at an input other than A

7. An internet protocol switching system in accordance with claim 1 wherein the message packet MA is sub-divided into segments and a decision to inject a plurality of segments of MA into data switch S depends at least in part on logic associated with output port X.

8. An internet protocol switching system in accordance with claim 1 wherein the message packet MA and a message packet MB from input port B are scheduled to enter data switch S in such a way that message packet MA and message packet MB enter output port X concurrently.

9. An internet protocol switching system in accordance with claim 4, wherein the logic L associated with output port X sets a time for input port A to begin sending message packet MA into data switch S.

10. A method in accordance with claim 5 wherein the monitoring of arriving message packets targeted for output port X is done by logic at X.
